(19) United States
(12) Patent Application Publication
(10) Pub. No.: US 2015/0065762 A1
(43) Pub. Date: Mar. 5, 2015

(54) CATALYTIC PYROLYSIS OF OLIVE MILL WASTE

(71) Applicant: Utah State University, North Logan, UT (US)

(72) Inventors: Foster Agblevor, Hyde Park, UT (US); Kamel Halouani, Sfax (TN)

(21) Appl. No.: 14/477,720

(22) Filed: Sep. 4, 2014

Related U.S. Application Data
(60) Provisional application No. 61/873,685, filed on Sep. 4, 2013.

(51) Int. Cl. B01J 23/78; B01J 21/06; B01J 21/12; C10G 1/00; C10L 1/04

(52) U.S. Cl. CPC B01J 23/78; C10G 1/00; C10L 1/04; B01J 21/12; B01J 21/063
USPC 585/16; 585/240; 502/242

(57) ABSTRACT

Methods and apparatus for producing bio-oil that include providing a catalyst that includes red mud in a catalyst bed in a fluid state, the catalyst being maintained at a temperature suitable for pyrolysis; providing a flow of a non-reactive fluid into the catalyst bed; entraining a biomass that includes olive mill waste in the flow of non-reactive fluid, so that the biomass is delivered to the catalyst bed; pyrolyzing the biomass; collecting gases and vapors that result from pyrolysis; and condensing the gases and vapors into bio-oil.

### TECHNICAL FIELD

The present disclosure relates to methods of catalytic pyrolysis. More specifically, this disclosure relates to catalytic pyrolysis of materials comprising olive mill waste sludge.

### BACKGROUND

Catalytic pyrolysis is an emerging technology that has the potential of producing liquid fuels from biomass feedstocks. The major advantages of the catalytic pyrolysis process are improvement in the stability of the pyrolysis oils because of cracking of the reactive species into either low molecular weight organics or gasification of some of this reactive species to carbon oxides and C₁-C₅ hydrocarbons, reduced viscosity, reduced oxygenation (i.e. improved deoxygenation) of the oils, and higher carbon content, which leads to higher heating values. The most effective catalysts used for conventional biomass pyrolysis to liquids are mostly acidic zeolites and modified forms of these catalysts. Although they produce relatively stable pyrolysis oils, they also generate considerable quantities of water, carbon oxides, and coke. This combination of gaseous products, coke and water constitute loss of hydrogen, carbon and reduction in the overall carbon and hydrogen efficiencies. Thus, there is a pressing need to develop new catalysts that improve carbon efficiency and yet produce stable pyrolysis oils.

### Olive Oil Mill Waste

The socio-economic importance of the olive oil production is significant, especially in the Mediterranean region, both in terms of wealth and tradition. Spain is the world's largest producer followed by Italy, Greece, Turkey, Syria and Tunisia. However, many other countries such as Argentina, Australia and South Africa are becoming emergent producers since they are promoting intensive olive tree cultivation.

As such, these areas may be affected by olive mill waste pollution. The extraction of olive oil generates huge quantities of wastes that may have a great impact on land and water environments because of their high phytotoxicity. In fact, several by-products are generated during the olive oil production process which include spent olives (fruit pits and solids after pressing, olive leaves from harvesting) and process wastewater that has high organic load. These by-products require specialized management to reduce environmental pollution.

The economical and environmentally sustainable methods of disposing these classes of wastes are still a challenge for the olive oil industry. In fact, olive oil mill wastewaters (OMWs) constitute a serious environmental issue in the Mediterranean countries. More than 30×10⁶ m³ of liquid and solid wastes are produced in the short harvesting season lasting between December and February containing a highly polluting organic load including sugars, tannins, polyphenols, polyalcohols, pectins, and lipids. Most frequently, OMWs are pumped and discharged into evaporation ponds, or directly dumped in rivers, or spread on soil.

Several studies have shown the negative effects of these wastes on soil microbial populations, on aquatic ecosystems, and even on air. The environmental concerns are mainly due to phenolic compounds, which contribute to the antimicrobial and phytotoxic effects of OMWs, thus limiting their biodegradability.

For many years, olive mill wastewater (OMW) has been the highest pollutant and troublesome waste produced by olive mills in all Mediterranean countries. Thus, the management of this liquid residue has been investigated. Because of the associated environmental problems and potential hazards, several OMW treatment technologies have been developed to minimize their environmental impact and lead to a sustainable use of resources. The proposed technologies include second oil extraction, combustion, gasification, anaerobic digestion, composting, and solid state fermentation.

Olive oil extraction involves different stages such as olive fruit washing, grinding, beating and oil extraction. The quantity and physico-chemical properties of the wastes generated depend on the oil extraction method. There are two ways of extracting olive oil: traditional pressing, used for many centuries with only minor modifications, and centrifugation, that was recently introduced into the industry. There are also two centrifugation systems; three-phase and two-phase systems that are described in FIG. 1.

Even though the traditional mechanical pressing is a relatively obsolete technology, it is still in use by small scale olive oil producers especially in Tunisia. After the mechanical pressing, a solid fraction, called olive husk, is obtained as by-product along with an emulsion containing the olive oil that is separated by decantation from the remaining OMW.

The three-phase system generates three fractions at the end of the process: a solid (olive husk or olive pomace) and two liquids (oil and wastewater). In spite of the advantages of this system compared to traditional mechanical pressing (complete automation, better oil quality, small footprint) it also has some disadvantages such as greater water and energy consumption, higher wastewater production and higher capital investment. OMW, generated by both systems (traditional and the three-phase system mills) have been illegally dumped in the soil or into nearby streams or rivers for many years. The continuous dumping and the rapid increase in the amount of wastes generated have brought about serious environmental problems in the Mediterranean region due to its high organic matter concentration and its phytotoxicity.

OMWs are the main pollutant from the three-phase extraction systems and traditional mills. They are composed of vegetable water from the fruit and the water used in different stages of oil extraction. They contain olive pulp, mucilage, pectin, oil, etc., suspended in a relatively stable emulsion.

The chemical composition o f OMW is variable depending on olive varieties, growing techniques, harvesting period, and oil extraction technology. The main characteristics of OMW are the high content of organic compounds such as organic acids, lipids, alcohols and polyphenols that are phytotoxic material. These characteristics pose significant environmental hazards when improperly managed. However, OMW also contains valuable resources such as a high organic matter concentration and a number of nutrients, especially potassium that could be recycled as a potential fertilizer. Table 1 shows the main chemical constituents and characteristics of OMW

TABLE 1
Main Chemical Characteristics of OMW (OMW) (n.d. means not determined).

| | (a) | (b) | (c) | (d) | (e) | (f) | (g) | (h) |
|---|---|---|---|---|---|---|---|---|
| Dry matter (%) | 6.35 | 7.1 | n.d. | n.d. | 7.19 | 6.33 | n.d. | n.d. |
| pH | 4.8 | 4.93 | 4.8 | n.d. | 5.17 | 5.00 | 4.2 | 5.0 |
| EC (dS/m) | 12.0 | 7.3 | n.d | 10.0 | 5.50 | n.d. | 7.0 | n.d. |
| OM (g/1) | 57.4 | n.d. | 62.1 | n.d. | 46.5 | 57.2 | n.d. | n.d. |
| TOC (g/1) | 39.8 | n.d. | n.d. | n.d. | 34.2 | n.d. | n.d. | n.d. |
| TN (g/1) | 0.76 | 0.62 | 0.79 | n.d. | 0.63 | 0.86 | 2.1 | n.d. |
| P₂O₃ (g/1) | 0.53 | n.d. | n.d. | n.d. | 0.31 | 0.61 | 0.7 | 0.7 |
| K₂O (g/1) | 2.37 | n.d. | n.d. | 2.9 | 4.46 | n.d. | 3.5 | 10.8 |
| Na (g/1) | 0.30 | n.d. | n.d. | 0.2 | 0.11 | n.d. | n.d. | 0.42 |
| Ca (g/1) | 0.27 | n.d. | n.d. | 0.2 | 0.30 | n.d. | n.d. | 0.64 |
| Mg (mg/1) | 44 | n.d. | n.d. | 92 | 129 | n.d. | n.d. | 220 |
| Fe (mg/1) | 120 | n.d. | n.d. | 18.3 | 68.5 | n.d. | n.d. | 120 |
| Ca (mg/1) | 6 | n.d. | n.d. | 2.1 | 1.5 | n.d. | n.d | 3 |
| Mn (mg/1) | 12 | n.d. | n.d. | 1.5 | 1.1 | n.d. | n.d. | 6 |
| Zn (mg/1) | 12 | n.d. | n.d. | 2.4 | 4.1 | n.d. | n.d. | 6 |
| d (g/cm³) | 1.048 | n.d. | n.d. | n.d. | 1.02 | 1.048 | n.d. | n.d. |
| Lipids (g/1) | 1.64 | 8.6 | 12.2 | n.d. | 3.1 | n.d. | n.d. | n.d. |
| Polyphenols (g/1) | 10.7 | 0.98 | 3.8 | n.d. | 1.6 | n.d. | 7.8 | n.d. |
| Carbohydrates | 16.1 | 4.8 | 4.7 | n.d. | 8.79 | n.d. | 1.4 | n.d. |
| (g/1) | | | | | | | | |
| COD (g/1) | 93 | 67 | 103 | 178 | n.d. | 130 | 177 | n.d. |
| BOD₃ (g/1) | 46 | n.d. | n.d. | n.d. | n.d. | 55 | 94 | n.d. |

In recent years many management options have been proposed for the treatment and valorization of OMW. Most of these methods aim at the reduction of the phytotoxicity in order to reuse it for agricultural purposes. Of these, there is little doubt that anaerobic digestion is the most environmentally compatible and least expensive wastewater treatment method, which may also overcome the problem of seasonal OMW production. Nonetheless, some bacteria (e.g., methanogens) are particularly sensitive to the excess inhibitory and/or toxic compounds such as phenolics, thus limiting the performance of anaerobic digesters. Consequently, several other methods have been investigated for OMW treatment. These include advanced oxidation processes (AOPs) such as ozonation, photocatalysis, hydrogen peroxide/ferrous iron oxidation (the so-called Fenton's reagent), and wet air oxidation.

Despite these efforts, an integrated solution has not yet been developed and the techniques that have been applied in each individual case present some technical and/or economic disadvantages and so have failed to provide a satisfactory solution to the problem.

Thus, waste treatment technologies that simultaneously generate energy as well as dispose of the waste represent an interesting alternative to current practices. In fact, anaerobic fermentation of OMW has been suggested as a means of solving this problem. Biogasification is an effective process for converting a broad variety of biomass to methane as a substitute for natural gas and medium calorific value gases. The process can be carried out in relatively inexpensive and simple reactor designs and operating conditions. Anaerobic digestion converts the carbonaceous matter into biogas leaving stabilized slurry in a form suitable for reapplication to land as fertilizer. Common materials used for methane generation are often defined as waste materials, i.e. crop residues, animal and urban wastes. Manures and process waste waters have been extensively investigated as sources of biogas.

In practice, the most common elimination method is through evaporation in storage ponds in the open fields because of the low capital investment required and the favorable climatic conditions in Mediterranean countries. However, this evaporation method requires large areas and produces several problems such as bad odor, ground water infiltration and insect proliferation. The evaporation of OMW produces sludge. The majority of the OMWS produced in evaporation ponds is disposed in landfills, although they may also be used either in agriculture or as a heat source because of the high calorific value due to the oil content. Most of the studies on revalorization of this sludge (OMWS) focus on composting. Paredes et al. (2002) studied the composting process of OMWS sludge with maize straw and cotton waste and concluded that this can be an environment-friendly alternative to OMWS disposal.

Some in the art have proposed the preparation of a fuel by mixing the OMWS with olive husk. Another way of recycling this waste was proposed by using OMWS as an additive for the development of construction materials. However, there are no studies in published or patent literature on the thermochemical conversion of OMWS to bio-oil using rapid conventional pyrolysis or advance catalytic pyrolysis. Extensive literature survey revealed limited research on pyrolysis of olive husk.

### Biodiesel

Biodiesel which is methyl or ethyl esters of fats and oils has become an important renewable transportation fuel both in the USA and European Union (EU) countries. According the US EPA, biodiesel production reached 900 million gallons in 2012 and increased to 1.36 billion gallons in 2013 with an annual production capacity was 2.3 billion gallons. Thus there is room to expand biodiesel production.

Presently, most biodiesel produced in the USA is derived from soybean oil, while rapeseed oil is the common feedstock for biodiesel production in EU countries. Biodiesel is used mostly in diesel trucks and farm equipment as B5, B10, or B20 blends in the USA. In EU countries, biodiesel is used in trucks as well as in cars and other vehicles.

Most biodiesel fuel produced in the USA and EU countries is based on transesterification technology where methanol is reacted with lipids catalyzed with either sodium methoxide or sodium hydroxide. That conventional method produces glycerol and methyl esters. For impure fats and oils containing free fatty acids, a two-step process is used to avoid soap (surfactant) production. The first stage of the reaction is catalyzed by sulfuric acid and the second stage is catalyzed by sodium hydroxide. The biodiesel is then separated from the glycerol, excess methanol, and soapstock. The product is then purified by either distillation or washed several times with water and dried.

The goal of the transesterification process is to reduce the viscosity of the oil for improved combustion in internal combustion (IC) engines. Refined vegetable oils without transesterification have viscosity almost ten times that of biodiesel and therefore do not perform very well in IC engines. The biodiesel however has very high oxygen content and therefore has lower energy density than petrodiesel. However, it burns cleaner and has less environmental pollution effect.

An alternative way of producing diesel fuel from lipids is through pyrolysis or hydrogenation of lipids. Conventional technologies rely on expensive catalysts and high temperature and pressure and, therefore, it is not profitable compared to the transesterification route. Therefore, there is a need to provide an inexpensive catalyst for the production of diesel equivalent fuel, and “green diesel” can be produced from any lipid.

### Automobile Shredder Residue

Automobile shredder residue (“ASR”) also known as autofluff is mostly organic residue after extracting all the metals from a discarded automobile. The ASR is composed of a complex mixture of materials including, leather, plastics, rubber, oil, and many other materials. Currently, these ASR materials are disposed in landfills. The cost of landfilling is becoming more expensive. ASR can either be combusted, gasified, or pyrolyzed to liquids. Combustion and gasification tend to produce undesirable products such as polychlorinated biphenyls (PCBs), polyaromatic hydrocarbons (PAH), and dioxins. The production of these compounds which are strictly regulated implies that the gases have to be extensively scrubbed before discharging into the atmosphere which makes the process expensive.

Pyrolysis however, does not require very high temperatures for converting the ASR into liquids and the reducing atmosphere employed minimizes the formation of dioxins, but PCBs could potentially be formed from chlorinated materials such as polyvinylchloride (PVC) in the ASR. High concentrations of PCBs in pyrolysis oils are undesirable; therefore any technologies developed to convert ASR into liquid fuels must address the prospect of PCB formation by avoiding the production of PCB.

### Plant Sources

Pinyon and juniper are invasive woody species in Western United States that occupy over 30 million hectares of land. The US Bureau of Land Management (BLM) has embarked on harvesting these woody species to make room for range grasses for grazing. The major application of harvested pinyon juniper (PJ) is low value firewood. Thus, there is a need to develop new, high value products from this woody biomass to reduce the cost of harvesting.

The juniper trees found in the PJ woodlands consist of alligator juniper (Juniperus deppeana Steud.), one-seed juniper (Juniperus monosperma (Engelm.) Sarg.), western juniper (Juniperus occidentalis Hook.), Utah juniper (Juniperus osteosperma (Torr.) Little), and Rocky Mountain juniper (Juniperus scopulorum Sarg.). The pinyon trees consists of Mexican pinyon (Pinus cembroides Zucc.), pinyon (Pinus edulis Engelm.), and singleleaf pinyon (Pinus monophylla Torr. and Frem.).

PJ woodlands domination decreases the herbaceous vegetation, increase bare lands which in turn increases soil erosion and nutrition loss. Studies have shown that expansion of PJ woodlands have reduced the magnitude of precipitation, and increased soil erosion by four times. PJ woodlands increase the potential of crown fires, which promote the infiltration of exotic species. Thus, land management agencies are focusing on reducing the population of PJ woodlands by bulldozing, chaining, hand cutting, mechanical removal, and prescribed fires. The harvested material is therefore a mixture of several species bundled together which are used for low value applications.

### SUMMARY

The present disclosure in aspects and embodiments addresses these various needs and problems by providing a method of producing bio-oil, the method comprising: providing a catalyst comprising red mud in a catalyst bed in a fluid state, the catalyst being maintained at a temperature suitable for pyrolysis; providing a flow of a non-reactive fluid into the catalyst bed; entraining a biomass comprising olive mill waste in the flow of non-reactive fluid, so that the biomass is delivered to the catalyst bed; pyrolyzing the biomass; and collecting gases and vapors that result from pyrolysis; and condensing the gases and vapors into bio-oil.

In one aspect, a method of producing bio-oil is disclosed wherein the method includes providing a catalyst bed in a fluid state, wherein the catalyst bed comprises red mud; heating the catalyst bed to a temperature suitable for pyrolysis; providing a flow of a non-reactive fluid onto the catalyst bed; providing feedstock in the flow of non-reactive fluid; pyrolyzing the biomass. In some embodiments, the feedstock is biomass.

In some embodiments, the catalyst bed is heated to a temperature of from about 400° C. to about 650° C. In some embodiments, the catalyst is heated to a temperature of from about 425° C. to about 600° C.

In some embodiments, the method also includes collecting gasses and vapors from pyrolyzing the biomass and condensing the vapor into a bio-oil and recovering the non-condensable gases.

In some embodiments, the non-reactive fluid is pyrolysis gas. In some embodiments, the pyroslysis gas is methane. In some embodiments, the non-reactive fluid is nitrogen gas. In some embodiments, the non-reactive fluid is carbon monoxide (CO).

In some embodiments, the feedstock is olive mill waste. In some embodiments, the feedstock is automotive shredder residue. In some embodiments, the feedstock is from virgin and waste vegetable oil or lipids. In some embodiments, the feedstock is plant matter.

In some embodiments, the method also includes providing calcium oxide and incorporating the calcium oxide onto the red mud and catalyst bed.

In another aspect, a bio-oil is disclosed that is prepared from any of the aforementioned methods.

In another aspect, a pyrolysis catalyst is disclosed that includes red mud. In some embodiments, the red mud comprises a mixture Fe₂O₃, Al₂O₃, SiO₂, CaO, TiO₂, and Na₂O. In some embodiments, that catalyst includes water in the form of a slurry having a pH of between about 8.5 and about 12. In some embodiments, the catalyst has a BET surface area of between about 30 and about 65 m2/g. In some embodiments, the catalyst also includes magnetite.

### BRIEF DESCRIPTION OF THE DRAWINGS

FIG. 1 is flow chart showing conventional olive oil waste processing.

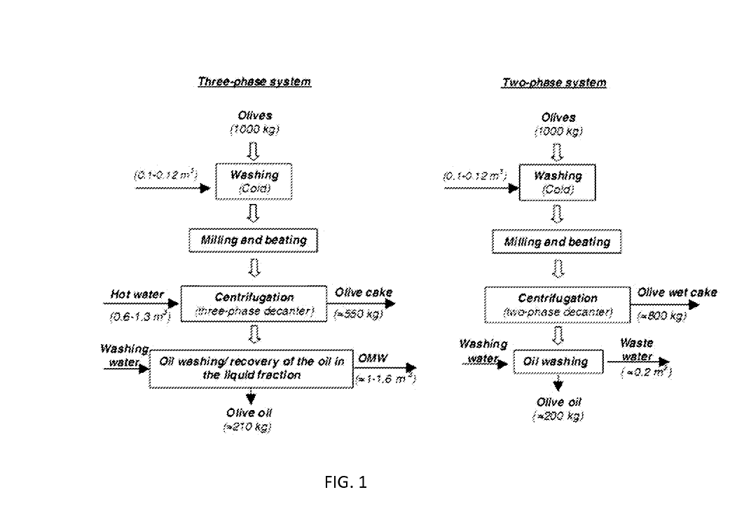

FIGS. 2 is schematic drawing of a bubbling fluidized bed pyrolysis unit.

FIG. 3 is shows the x-ray diffraction patterns of different red mud samples where H=hematite, M=magnetite.

FIG. 4 is the ¹³C-NMR spectrum of red mud catalyzed OMWS pyrolysis liquid product.

### DETAILED DESCRIPTION

The present disclosure describes apparatuses and associated methods for producing bio-oil from various sources. In the following description, numerous specific details are provided for a thorough understanding of specific preferred embodiments. However, those skilled in the art will recognize that embodiments can be practiced without one or more of the specific details, or with other methods, components, materials, etc. In some cases, well-known structures, materials, or operations are not shown or described in detail in order to avoid obscuring aspects of the preferred embodiments. Furthermore, the described features, structures, or characteristics may be combined in any suitable manner in a variety of alternative embodiments. Thus, the following more detailed description of the embodiments of the present invention, as illustrated in some aspects in the drawings, is not intended to limit the scope of the invention, but is merely representative of the various embodiments of the invention.

In this specification and the claims that follow, singular forms such as “a,” “an,” and “the” include plural forms unless the content clearly dictates otherwise. All ranges disclosed herein include, unless specifically indicated, all endpoints and intermediate values. In addition, “optional” or “optionally” refer, for example, to instances in which subsequently described circumstance may or may not occur, and include instances in which the circumstance occurs and instances in which the circumstance does not occur. The terms “one or more” and “at least one” refer, for example, to instances in which one of the subsequently described circumstances occurs, and to instances in which more than one of the subsequently described circumstances occurs.

The present disclosure describes methods, compositions, reagents, and kits for pyrolyzing various fuel sources or biomass feedstocks. In some embodiments, the fuel source is olive mill waste. In some embodiments, the fuel source is plant material, for example woody plant materials. In some embodiments, the fuel source is vegetable oil. In some embodiments, the fuel source is automobile shredder residue.

The disclosed methods involve the rapid catalytic pyrolysis (“RCP”) of the various fuel sources. For example, olive mill wastewater sludge (OMWS) is catalytically converted to high calorific-value biofuel called “Olidiesel” using catalysts such as red mud and/or zeolites. The present disclosure also covers methods of using red mud as a catalyst for the pyrolysis of other biomass feedstocks.

The rapid catalytic pyrolysis of OMWS is a thermal treatment process that uses catalysts such as red mud in the absence of oxygen, to produce char, and liquid and gaseous products. In exemplary processes, the temperature at which pyrolysis is carried out may be from about 400-600° C., and the reactant residence time may be from about 1-5 seconds. U.S. Pat. No. 8,202,332 (the entirety of which is hereby incorporated by reference), describes related methods for fractional catalytic pyrolysis that allow for conversion of certain biomasses and catalysts into a slate of desired products without the need for post-pyrolysis separation and the advantages those methods have over conventional rapid pyrolysis methods. The methods used therein describe processes with different biomass feedstocks and catalysts, however, the general temperatures, machinery, and processes may be used with the feedstocks and catalysts described herein.

In the RCP process, deoxygenation of the liquid product may be a primary objective. This contrasts to conventional rapid pyrolysis (RP) processes, where high liquid yield is the main objective. The liquid product in RP processes is also referred to in the literature as biocrude or bio-oil or pyrolysis oil. In general, pyrolysis oils are unstable, acidic, corrosive, viscous, and have high water and ash contents. The RP process produces pyrolysis oils or bio-oils that can be upgraded for various applications including heating oils, resins and adhesives, liquid smoke and many others. In contrast, catalytic pyrolysis oils tend to be more stable, less acidic, and have higher energy density and therefore have wider applications.

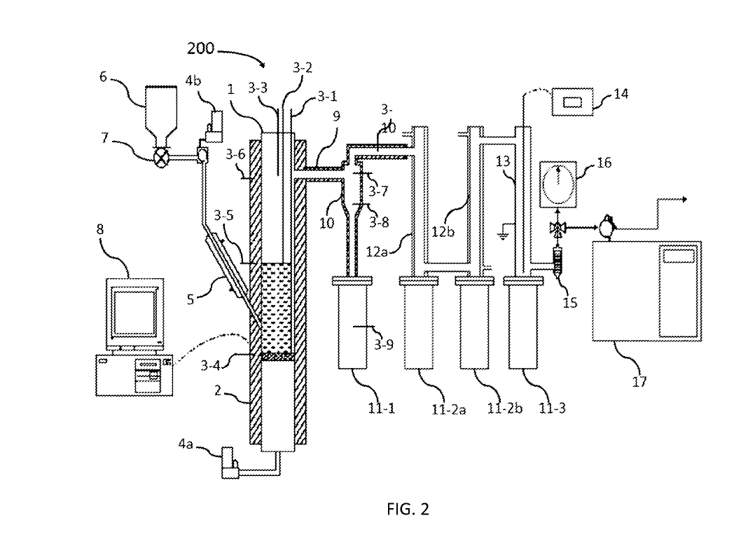

The OMWS RCP may be conducted in a bubbling fluidized bed reactor, such as the reactor located at the USTAR Bioenergy Center, Utah State University in Logan, Utah (see FIG. 2). An exemplary bubbling fluidized bed pyrolysis unit includes a pyrolysis reactor 1, a furnace 2, one or more thermocouples 3, a mass flow meter 4, a heat exchanger 5, a feed hopper 6, a screw feeder 7, an optional controller such a computer 8, a heating tape 9, a hot gas filter 10, one or more sample collectors 11-1, 11-2a, 11-2b, 11-3, one or more condensers 12a and 12b, an electrostatic precipitator 13, a high voltage generator 14, a coalescing filter 15, a wet gas meter 16, and a gas chromatograph 17.

The reactor may comprise 50-mm (2-in) scheduled 40 stainless steel pipe, 500 mm (20-in) high (including a 140-mm (5.5 in) preheater zone below the gas distribution plate) and be equipped with a 100-μm porous metal gas distributor.

In some embodiments, the fluidizing medium may be a red mud catalyst (100-150 g) of particle size 125-180 μm and the bed may be fluidized with nitrogen or recycled gas. The reactor tube, which contained a bubbling fluid bed with back-mixing of the feed, may be externally heated, for example with a three zone electric furnace.

In some embodiments, the red mud catalyst may be used with other biomass feedstocks, such as pinion juniper, other woody biomasses, and other conventional biomasses, alone or in combination with OMWS.

### OMWS Material Preparation

Any OMWS material may be used as feedstock for the RCP process. In some embodiments, the material may be dried and then ground in a Wiley mill (model 4) until all the material went through about a 2-mm sieve. The dried ground OMWS (20-mesh) may be oily and sticky, so it may be mixed with 20-30 wt % biochar derived from either OMWS or woody biomass to improve its flow and feeding into the reactor.

The moisture content of the OMWS may range from about 1.41 to about 6.4 wt %; its ash content may range from about 13 to about 25 wt %; the carbon content may range from about 52.9 to about 53.65 wt %; the average hydrogen content is equal to about 7%. The nitrogen, sulfur and chlorine contents of OMWS were low (1.96, 0.6 and 1 wt % respectively). Table 2 is exemplary of these parameters.

TABLE 2
Properties of OMWS

| | |
|---|---|
| Moisture | 4.08 |
| Ash | 13.36 |
| Carbon | 52.89 |
| Hydrogen | 7.16 |
| Nitrogen | 1.96 |
| Sulfur | 0.60 |
| Oxygen (by difference) | 24.03 |
| HHV | 25.64 (dry basis) |

### Red Mud Catalyst Preparation

Red mud or red sludge is the solid residue from the processing of bauxite to alumina using the Bayer process. Red mud is a complex mixture of metallic oxides such as ferric oxide, aluminum oxide, titanium dioxide, magnesium oxide, calcium oxide, silicon oxide, and other minor compounds, in addition to the residual sodium hydroxide used in the extraction process. In conventional applications using red mud, the red mud is activated through acid treatment and other modifications. However, there has not been any systematic investigation of using untreated or raw red mud as fractional catalytic pyrolysis or RCP catalyst.

Any red mud may be used in the RCP process. Red mud supplied by Sherwin Alumina Co LLC, (Gregory, Tex.), for example, may be used. It may be dried, ground and sieved to appropriate particle size (125-180 μm) for fluidized bed pyrolysis.

The composition of the red mud may be determined using XRD analysis and surface area determined using Quantachrome BET surface analyzer (Quantachrome Instruments, Boyton Beach, Fla.). The red mud water slurry may have a pH of 9-12, for example a pH of 9, and the dry ground material may have a BET surface area of 30-65 m²/g. The red mud may comprise a mixture of metal oxides comprised of Fe₂O₃ (30-60 wt %), Al₂O₃ (5-20 wt %), SiO₂ (5-10 wt %), CaO (5-20 wt %), TiO₂ (5-15 wt %), and Na₂O (3-10 wt %). In some embodiments, the red mud may comprise the following specific wt %: Fe₂O₃ (53.98 wt %), Al₂O₃(13.53 wt %), SiO₂(8.91 wt %), CaO(8.87 wt %), TiO₂(6.18 wt %), and Na₂O(5.83 wt %). Varying wt % of metal oxides may be used however by the processes disclosed herein. The red mud need not be activated before being used. The red mud catalyst may, however, be calcined at 500-550° C. for 2-3 hours to convert the Gibbsite and Geothite to Al2O3 and Fe2O3 respectively before being used for the pyrolysis.

After the red mud catalyst has been used in the RCP processes described herein, the red mud exhibits magnetic properties and may be used for other applications where magnetic properties are desirable.

The following examples are illustrative only and are not intended to limit the scope of the broadest disclosure.

### Catalytic Pyrolysis of OMWS

The catalytic pyrolysis of the OMWS samples were conducted in a 2-inch fluidized bed reactor as depicted in FIG. 2. The ground biomass was fed into a hopper and conveyed by K-Tron screw feeder (K-tron Process Group, Pitman, N.J.) into an entrainment zone where it was entrained by nitrogen carrier gas and through an air-cooled feeder tube into the bubbling fluid bed. The bubbling fluid bed was red mud catalyst (100 g). The pyrolysis temperatures investigated were 400, 450, 500 and 550° C., and the apparent pyrolysis vapor residence time was less than 5 seconds at atmospheric pressure. The fluidizing gas was nitrogen at a flow rate of 6.5 L/min. The OMWS feed rate was 100-150 g/h and weight hourly space velocity was 1.0 -1.5 h⁻¹. The pyrolysis products exiting the reactor were first separated with a hot gas filter to collect the solid residue and some entrained catalyst. The vapors and non-condensable gases exiting the hot gas filter were then passed through two ethylene glycol cooled condensers maintained at 10° C. and 4° C. respectively to condense the pyrolysis vapors. The non-condensable gases and aerosols were then passed through an electrostatic precipitator maintained at 20-30 kV to condense the aerosols. The clean non-condensable gases (NCG) were then passed through a coalescing filter and a totalizer and then sampled online with Varian microGC gas chromatographic analyzer. The excess gases were vented through a flare.

All the reaction apparatus (reactor, hot gas filter, condensers, electrostatic precipitator) were weighed before and after each experiment. This enabled a gravimetric determination of the yield of various components. The pyrolysis times were 120 to 180 minutes. In order to determine the catalyst activity, oils samples were collected at 60 minute intervals and their viscosities measured. Additionally the gaseous products were analyzed every 7 minutes to follow the composition of the gases which is related to the catalyst activity. All experiments were conducted in triplicates to determine reproducibility. In addition, some red mud catalysts was regenerated after the first run and reused for the pyrolysis. The feed rate, gas flow rate and reactor temperature were maintained constant during each run. The red mud catalyst bed and reactor temperatures were measured and controlled by three K-thermocouples inserted into a thermal well in the reactor.

### Results

Olive mill wastewater sludge (OMWS) was mixed with 20 wt % pinewood biochar and loaded into a K-tron feed hopper. The fluidized bed was filled with 100 g of red mud of particle size 125-180 μm and heated to 450° C. using a three zone electric furnace. The fluid bed was fluidized with nitrogen gas at a flow rate of 6.5 L/min. The mixture of OMWS and pine biochar was fed at 100-150 g/h into 2-in fluidized bed pyrolysis reactor and pyrolyzed at 450° C. The residence time of the pyrolysis vapors was 1-5 seconds. The pyrolysis vapors and char were passed through a hot gas filter to separate the biochar from the pyrolysis vapors. The vapors were then passed through two ethylene glycol-cooled condensers maintained at 10° C. and −10° C. where the vapors were condensed. The non-condensable gases (NCG) and aerosols were then passed through an electrostatic precipitator (ESP), where the aerosols were condensed, and the NCG were then passed through a coalescing filter and slip stream was sampled with microGC for gas monitoring.

The oil collected in the condenser formed two phases: aqueous and organic. The oil in the ESP was a single phase. The pH of the oil was between about 6.5 and about 7.0. The properties of the products and various effects are shown in Tables 3-5.

TABLE 3
Product distribution and properties of liquid and composition
of non-condensable gases at 450 C.

| | Sand | Red mud |
|---|---|---|
| Total liquid yield (wt %) | 49.7 | 47.3 |
| Organic liquid yield (wt %) | 33.2 | 34.1 |
| Aqueous liquid yield (wt %) | 16.29 | 13.3 |
| Char yield (wt %) | 29.1 | 22.7 |
| Gas yield (wt %) | 20.9 | 30.0 |
| ESP Oil pH | 6.6 | 7.1 |
| ESP Oil viscosity @40 C. (cP) | 24.34 | 5.4 |
| Density (g/cm³) | 0.92 | 0.91 |
| HHV (MJ/kg) | 37.83 | 40.4 |
| C (%) | 66.4 | 81.8 |
| H (%) | 9.39 | 10.5 |
| N (%) | 3.45 | 2.5 |
| O (%) | 20.81 | 5.2 |
| S (%) | 0.00 | 0.0 |

Non-condensable gas composition

| | | |
|---|---|---|
| H2 (wt %) | 0.8 | 3.8 |
| CO (wt %) | 6.7 | 7.3 |
| CO2 (wt %) | 78.0 | 72.5 |
| CH4 (wt %) | 1.9 | 2.6 |
| C1-C4 hydrocarbons (wt %) | 10.0 | 10.8 |
| Other hydrocarbons (wt %) | 2.6 | 2.9 |

TABLE 4
Effect of temperature on the yield of red mud pyrolysis
products distribution and properties of liquid
product. Sand pyrolysis is used as reference.

| Pyrolysis medium | Sand | Red mud | | |
|---|---|---|---|---|
| Pyrolysis temperature (° C.) | 450 | 400 | 450 | 500 |
| Organic liquid (wt %) | 34.8 | 35.0 | 34.1 | 31.0 |
| Water (wt %) | 9.4 | 11.6 | 13.3 | 11.3 |
| Total liquid (organic + water) (wt %) | 44.1 | 46.5 | 47.3 | 42.3 |
| Char (wt %) | 25.5 | 29.1 | 22.7 | 20.4 |
| Non-condensable gases (wt %) | 30.3 | 24.3 | 30.0 | 37.3 |
| Liquid pH | 6.6 | 7.1 | 7.3 | 7.4 |
| Liquid viscosity at 40 C. (cP) | 24.3 | 9.2 | 5.4 | 4.6 |
| Liquid HHV (MJ/kg) | 37.56 | 39.5 | 40.4 | 41.3 |

TABLE 5
Effect of temperature on the volumetric composition of pyrolysis gases.

| Pyrolysis medium | Sand | Red mud | | |
|---|---|---|---|---|
| Pyrolysis temperature (° C.) | 450 | 400 | 450 | 500 |
| H2 (vol %) | 15.11 | 31.53 | 44.91 | 44.19 |
| CO (vol %) | 8.63 | 6.26 | 6.17 | 8.91 |
| CO2 (vol %) | 63.87 | 52.77 | 38.99 | 34.09 |
| CH4 (vol %) | 4.18 | 3.01 | 3.88 | 5.40 |
| C2-C4 (vol %) | 6.94 | 5.67 | 5.11 | 6.57 |
| Other hydrocarbons (vol %) | 1.27 | 0.77 | 0.93 | 0.84 |

The properties of the oil clearly showed that the red catalytic pyrolysis had a major effect on the composition and its physico-chemical properties. The viscosity of the oil was about threefold less than the oil produced without the catalyst. The higher heating value (HHV) of the red mud pyrolysis was also higher than that from the sand pyrolysis oil. The HHV of the red mud pyrolysis oil is higher than that of biodiesel (37 MJ/kg) and almost equal to that of petrodiesel (42 MJ/kg). Thus, this fuel can be used as received without further processing such as distillation.

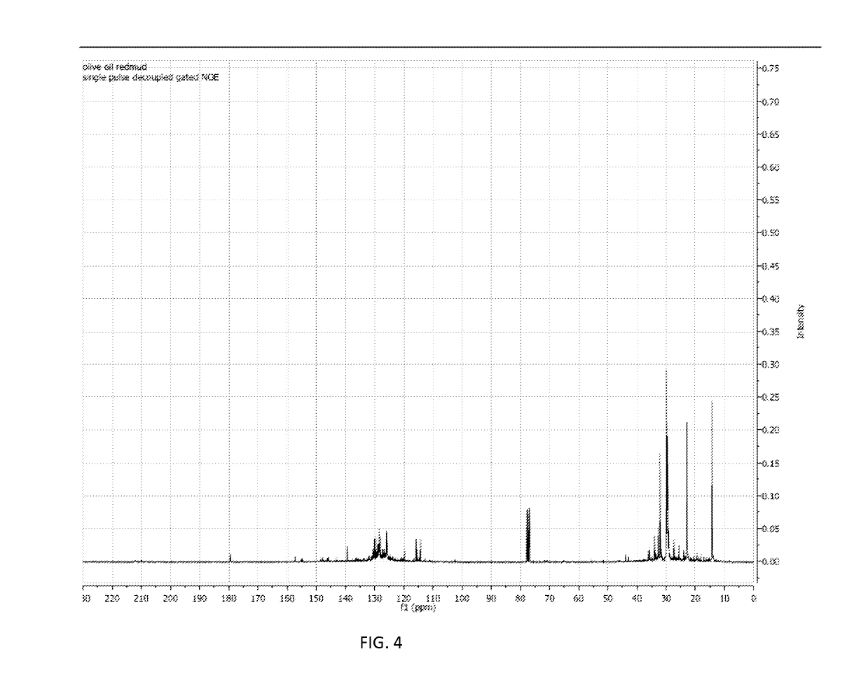

A very important property of pyrolysis oils is the pH and total acid number. In this case, the pH of the red mud pyrolysis oil is near neutral and the total acid number was 3 which implies that this oil will not be corrosive. For the pyrolysis of the OMWS using sand, acidic groups such as hexadecanoic, oleic, octadecanoic and their corresponding esters were identified using gas-chromatography mass spectrometry (GC/MS) (see results in Table 6). When red mud catalyst was used, however, no acidic functional groups were detected in the oil fractions, but ketones were detected (see C¹³-NMR spectrum in FIG. 4). This implies that acidic groups were converted into ketones through ketonization pathway catalyzed by the red mud. This reaction is known to result in the production of carbon dioxide. Oxygen rejection through CO₂ has been reported as through ketonization reactions, which converted carboxylic acids to ketones and released CO₂ (Deng et al, 2009; Peters et al, 2010, Gaertner et al 2009)

TABLE 6
Major peaks of bio-oil (>1%) pyrolyzed
without catalyst and identified by GC-MS

| | Retention time | Percentage | |
|---|---|---|---|
| No. | (min) | (%) | Chemical name |
| 1 | 14.149 | 1.29 | Pentadecane |
| 2 | 16.379 | 1.60 | 8-Heptadecene |
| 3 | 16.450 | 1.27 | 1-Heptadecene |
| 4 | 18.916 | 1.98 | Heptadecane |
| 5 | 19.624 | 7.28 | Hexadecanoic acid |
| 6 | 19.849 | 2.75 | Hexadecanoic acid, |
| | | | ethyl ester |
| 7 | 20.746 | 1.88 | Unknown |
| 8 | 20.793 | 3.33 | Unknown |
| 9 | 20.934 | 4.62 | 9-Octadecenoic acid |
| | | | (Z), methyl ester |
| 10 | 21.477 | 28.54 | Oleic acid |
| 11 | 21.583 | 9.72 | Ethyl oleate |
| 12 | 21.808 | 5.85 | Unknown |
| 13 | 22.351 | 2.22 | Unknown |
| 14 | 22.469 | 2.39 | Unknown |

### Experimental Methods for Processing Waste Vegetable Oils

Both free fatty acids and triglycerides can be converted into “green diesel” fuel. This process avoids the use of excess methanol and sodium hydroxide catalysts and can be separated in situ without washing and other steps currently required for the methyl ester production and purification.

The feedstock required for this process can by any waste vegetable oil, animal fats, inedible oils, or refined oils. Untreated red mud is the catalyst required for the process. The reaction is conducted in the fluidized bed reactor as described for the case of the olive mill wastewater sludge.

In one embodiment, the red mud is calcined at 550° C. for three hours or overnight before being used for the fluidized bed pyrolysis reaction. The major difference between the catalytic pyrolysis of waste vegetable oils (WVO), ASR and OMWS is the physical state of the feedstocks. In case of the ASR and OMWS which are solids, the feeding into the reactor was done using a twin screw feeder and pneumatic transport into the pyrolysis zone. In the case of the WVO and other lipids, a syringe pump was used to meter the liquid into the reactor. The feed line was preheated to facilitate the flow of the liquid into the reactor. The feed rate varied from 20 ml/h to 30 ml/h. The red mud used was 100 g and the fluidizing gas was nitrogen. The pyrolysis was conducted at 400 and 450° C. Higher temperatures were not used because of potential cracking of WVO to gaseous products and water.

The gaseous products were analyzed online using 490 microGC as described in the case of the ASR and OMWS. The pyrolysis oils were characterized in a similar manner as the ASR and OMWS oils.

For these studies both virgin olive oil and soybean oils were investigated but only the results for the soybean oil are reported here. The pyrolysis oil product yields distribution and properties of the oils are shown in Table 7. It is clear from the observed yields data that the pyrolysis temperature had a significant effect on the yield of the organic fraction of the total liquids. With increase in pyrolysis temperature, the amount of pyrolytic water remained almost the same, but the organic liquid fraction decreased probably because there was cracking which increased the gas yield. It is interesting to note that although there was cracking of the organic liquid fraction, this neither formed coke nor water; instead, it formed mostly gases, because the coke yield decreased with increase in pyrolysis temperature. This observation is contrary to the conventional cracking of most biomass liquid fractions which normally produce coke, water, and gases. The coke formation however decreased with increase in pyrolysis temperature because red mud is less active at 400 compared to 450° C.

The organic elemental composition of the pyrolysis oils showed a considerable reduction in the oxygen content of the oils at both pyrolysis temperatures (Table 7). At 400° C., there was 71% reduction in the oxygen content of the oil relative to the refined soybean oil while at 450° C., there was 78.7% reduction in oxygen content of the pyrolysis oil. The oxygen content of the pyrolysis oils 2-3% compared to 10-11% of biodiesel. Because of the deoxygenation of the pyrolysis oil there was a relative increase in the carbon content and subsequently the higher heating value (HHV) increased to 44.2 MJ/kg which is very close to that of No. 2 diesel fuel. This fuel also has the advantage that the sulfur level was below the detection limit of the analytical instrument. The densities and viscosities of the pyrolysis oils are similar to that of soybiodiesel.

Observations from ¹³C NMR spectra or reaction products oils show the absence of free fatty acid or ester signals; instead there were ketone carbon signals. Since the red mud contains some alumina, the alumnia may contribute to or be responsible for ketonization reactions. At higher pyrolysis temperatures however, the ketone signals were weaker, which suggests that ketonization reactions were favored by lower pyrolysis temperatures.

The FTIR spectra of the refined soybean oil and the pyrolysis oils at the two temperatures clearly show that the ester peak at 1743 cm⁻¹ in the refined oil was no longer present in the pyrolysis oils and the glycol peaks at 1159 cm⁻¹ were no longer present in the pyrolysis oils. It is unclear what products were formed from the glycerol decomposition component of the oil. Considering the significantly large amount of carbon oxides and pyrolytic water in the total liquids, the glycerol portion of the triglyceride may convert into mostly water and carbon oxides. The FTIR spectrum of the pyrolysis oils showed a ketone peak at 1717 cm⁻¹ which corroborates the ¹³CNMR data.

TABLE 7
Product distribution for the catalytic pyrolysis of
soybean_oil over regenerated red mud using nitrogen as fluidizing gas.

| | Refined | Pyrolysis oil yields (wt %) | |
|---|---|---|---|
| Pyrolysis temperature | soybean oil | 400° C._{—} | 450° C._{—} |

| | | |
|---|---|---|
| Coke | 11.9 | 6.2 |
| Total Liquid | 60.0 | 55.6 |
| Organic fraction | 46.43 | 40.82 |
| Pyrolytic water | 13.57 | 14.73 |
| Gases* | 27.4 | 38.3 |

Properties of Refined soybean oil and soybean pyrolysis oils

| | | | |
|---|---|---|---|
| Viscosity (cP) @40 C. | 28.64 | 3.92 | 3.61 |
| Density (g/cm³) @40 C. | 0.90 | 0.86 | 0.87 |
| C (%) | 77.16 | 84.42 | 85.56 |
| H (%) | 11.80 | 12.35 | 11.94 |
| N (%) | 0.07 | 0.10 | 0.14 |
| S (%) | 0.00 | 0.00 | 0.00 |
| O*(%) | 11.00 | 3.13 | 2.34 |
| HHV (MJ/kg, dry basis) | — | 44.20 | 44.21 |

*Determined by difference.

The gas yield was relatively high compared to woody biomass pyrolysis gases and increased with increase in pyrolysis temperature (Table 7). The gas composition (Table 8) showed a similar trend as those observed for other red mud catalyzed reactions, in that the hydrogen was highest on mole basis compared to reactions on sand or catalyzed by HZM-5. This high level of hydrogen production was attributed to the formation of olefinic bonds and cyclization of some of the straight chain hydrocarbons to aromatic compounds after deoxygenation. The deoxygenation reactions contributed to the CO and CO2 contents of the gases. The high molar concentration of the hydrogen implies that these gases can be either used for Fisher-Tropsch reactions or combusted as fuel for the pyrolysis process.

TABLE 8
Composition of pyrolysis gases for the catalytic pyrolysis of soybean
oil over regenerated red mud using nitrogen as the fluidizing gas.

| | Pyrolysis temperature | | | |
|---|---|---|---|---|
| | 400 C. | 450 C. | 400 C. | 450 C. |
| Gases | Composition (mole %) | | Composition (mass %) | |
| H₂ | 58.43 | 58.52 | 1.06 | 1.95 |
| CO | 6.67 | 8.51 | 1.68 | 3.94 |
| CO₂ | 21.1 | 18.20 | 8.35 | 13.24 |
| CH₄ | 1.96 | 2.78 | 0.28 | 0.74 |
| C₂-C₅ | 10.6 | 11.03 | 4.77 | 8.63 |
| Other hydroc. | 1.24 | 0.96 | 0.80 | 1.14 |

Thus, red mud can be used to deoxygenate waste vegetable oil to high hydrocarbon liquid fuels with very low oxygen content. In some products, the resulting fuel is primarily ketones. In some products, the process deoxygenates fatty acids into less oxygenated products including lipids and other hydrocarbons. In some embodiments, the red mud pyrolysis of triglycerides and free fatty acids produces large fractions of hydrogen through cyclization reactions.

Red mud was found to be an effective catalyst for deoxygenation and ketonization of waste vegetable oils to produce “green diesel”. The oxygen content of the waste vegetable oil was reduced from 11% to 2.4% for the green diesel using the red mud as catalyst at temperatures of 400 to 450° C. The yield of green diesel ranged from 60 to 55% and gas yield ranged from 20 to 35% and coke yield ranged from 6 to 10%. The liquid had a HHV of 44.2 MJ/kg compared to 37.75 MJ/kg for soybiodiesel, but the viscosity and density of the oil was similar to that of soybiodiesel. The gas was predominantly hydrogen (55 mol %) plus low quantities of CO2, CO, and light hydrocarbons. This resulting green diesel could be used in place of No 2 petrodiesel fuel.

In some embodiments, the red mud catalyst is doped with CaO.

The pyrolysis experiments on the automobile shredder residue (ASR) were conducted in a bench scale fluidized bed reactor of capacity 200 g/h. The ASR was ground in a Wiley mill (model 4) until the entire material passed through a 2-mm screen. The ASR was not sorted but was ground as received and it contained about 3 wt % moisture.

The red mud supplied by Sherwin Alumina Co LLC, (Gregory, Tex.), was dried at ambient laboratory conditions, ground with mortar and pestle and sieved to appropriate particle size (125-180 μm) for fluidized bed pyrolysis studies. The red mud was calcined at 550° C. overnight before being used for the pyrolysis. The calcination step can be used to affect the Gibbsite and Geothite contents of the red mud and convert it into alumina and ferric oxide respectively and release water (see equation 1 and 2). If the calcinations step is avoided, the oil will contain water, sometimes an excessive or undesirable amount. Because the decomposition of Gibbsite and Geothite to alumina and ferric oxide receptively occur between 200 and 350° C., these will occur during the preheating of the red mud to the pyrolysis temperature of 450-550° C. and this water will condense in the condensers.

2Al(OH)₃═Al₂O₃+3H₂O (1)

2FeO(OH)═Fe₂O₃+H₂O (2)

The composition of the red mud was determined by x-ray diffraction (XRD) using X'Pert Pro XRD spectrometer (PANanalytic Inc, Westborough, Mass.) and x-ray florescence (XRF) using Phillips PW2404 XRF spectrometer (PANanalytic Inc, Westborough, Mass.). The Brunauer-Emmett-Teller (BET) method was used to measure the specific surface area of the red mud using Quantachrome BET surface analyzer (Quantachrome Instruments, Boyton Beach, Fla.).

The catalytic fast pyrolysis experiments were carried out using a bench-scale fluidized bed reactor located in the USTAR Bioenergy Center, Utah State University, Logan, Utah (FIG. 2). The pyrolysis unit comprised of a K-Tron volumetric feeder, a 50 mm in diameter and 500 mm high bubbling fluidized bed reactor equipped with a 100-μm porous metal gas distributer. The reactor was externally heated with a three-zone electric furnace (Thermcraft, Winston-Salem, N.C.) and was connected, in series, to a hot gas filter, two condensers cooled with ethylene glycol/water mixture, an electrostatic precipitator (ESP) and a coalescing filter. A slip stream of the pyrolysis gases from the coalescing filter was sent to an SRI gas chromatograph (SRI Instruments, Torrance, Calif.) for analysis and samples collected in gas bags were also analyzed by 490 microGC (Agilent Technologies, Santa Barbara, Calif.). 100 g silica sand or red mud were used as the fluidizing medium. When using silica sand (250-425 μm) as the fluidizing medium, a total of 18.3 L/min of nitrogen gas was used to fluidize the bed and entrain the feedstock into the reactor. Using a screw feeder, the feedstock was conveyed from the hopper to an entrainment zone where nitrogen gas was used (5 L/min for both catalytic and non-catalytic experiments) to entrain the feed through a jacketed air-cooled feeder tube into the fluidized bed.

During pyrolysis, the mixture of vapours, gases and some of the biochar that exited the reactor were separated by the hot gas filter maintained at 400° C. to avoid the condensation of vapours going through it. The biochar particles were collected in the hot gas filter, while the biochar-free vapours and non-condensable gases passed through two condensers connected in series. These condensers were maintained at 4-10° C. using an 18-liter Haake A82 Temperature Bath/Recirculator (Haake, Karlsruhe, Germany). The cooling was a mixture of 50/50 ethylene glycol and water. The aerosols and non-condensable gases that escaped the condensers were passed through an electrostatic precipitator (ESP) maintained at 20 kilovolts. The aerosols which escaped the ESP were trapped in a F72C Series oil removing coalescing filter (NORGREN, Littleton, Colo., U.S.A.). The clean non-condensable gases that came out of the coalescing filter were passed through a totalizer to measure the total amount (litres) of gases (nitrogen and pyrolysis gases). A sample of the non-condensable gases that came out of the coalescing filter was injected, every 10 minutes into the Varian 490-micro gas chromatograph.

The liquid (organics/water) and solid (char/coke) product yields were determined gravimetrically by weighing the reactor, hot-gas-filter, water chilled condensers, and the ESP before and after each experiment. The pyrolysis experiments lasted for 2 hours each. All experiments were replicated.

### Bio-Oils Characterization

The pyrolysis liquids collected from the condensers and the ESP were analysed for their moisture content. The moisture content was determined by volumetric Karl Fisher titration method. A Metrohm 701KF Titrino (Brinkmann Instruments, Inc., NY, USA) and a 703 titration stand using Hydranal® composite 5 reagent. The bio-oils collected in the ESP were used for further analysis since they had very low (<1.0 wt. %) water content. The dynamic, kinematic viscosities and the densities of the oils were measured at 40° C. using a SVM 3000 Stabinger viscometer (Anton Paar USA Inc, Ashland, Va.). The heating values were determined using the IKA C2000 basic bomb calorimeter (IKA Works, Inc., NC, USA). The elemental compositions of the bio-oils were determined using a Thermo Scientific Flash 2000 organic elemental analyzer (ThermoFisher Scientific, Cambridge, UK). The sample size was 2-4 mg and the oxygen content of the oils was determined by difference. The ¹³C NMR spectra of the ESP oils were obtained using a JOEL 300 MHz NMR spectrometer (JOEL Ltd, Tokyo, Japan). The ¹³C NMR samples were prepared by dissolving approximately 0.1-0.2 g pyrolysis oils in 0.7 g deuterated dimethylsulfoxide (DMSO-d₆) (Sigma Aldrich, St. Louis, Mo., USA). The pulse width was 14.75 μs and the acquisition time was 1.57 s with a 2 seconds relaxation delay and 3000 scans were acquired.

### Characterization of Raw Automotive Shredder Residue (ASR)

The ultimate and proximate compositions of the ASR obtained from Western Metals Recycling (Western Metals Recycling, Plymouth, Utah) are shown in Table 9. The samples were very high in ash content even after sieving to remove some stones from the sample. The ash content also showed variation between the ultimate and proximate values because of the heterogeneous nature of the feedstock. The fixed carbon content was very low compared to woody biomass. The moisture content as expected was very low, but the higher heating value (HHV) was relatively high compared to woody biomass inspite of the high ash content of the feedstock. This was probably because of the plastics and rubber content of the feedstock which increased the heating values.

TABLE 9
Elemental composition of automotive shredder residue (ASR) feed
Ultimate analysis

| | Carbon (%) | Hydrogen (%) | Nitrogen (%) | Sulfur (%) | Ash (%) | Oxygen (%) | Moisture (%) |
|---|---|---|---|---|---|---|---|
| Auto fluff feed | 35.92 ± 0.24 | 4.34 ± 0.01 | 0.87 ± 0.03 | 0.32 ± 0.01 | 37.20 ± 0.96 | 21.35 ± 1.22 | 1.72 ± 0.07 |
| (wt. %) | | | | | | | |
| (Dry basis) | 36.55 | 4.22 | 0.88 | 0.33 | 37.85 | 20.17 | |

Proximate analysis

| Water (%) | Fixed carbon (%) | Volatile matter (%) | Ash (%) |
|---|---|---|---|
| 1.71 | 1.91 | 61.11 | 35.27 |

Physical properties

| Bulk density (g/cm³) | HHV (MJ/kg) |
|---|---|
| 0.314 | 20.69 |

The elemental composition of the ash showed a large number of elements present (Table 10). Calcium content of the ASR was the highest probably because of contaminants from the soil and other sources. Iron, aluminum, and copper contents as expected were high because these are used to make various components of the automobile; during the shredding process pieces of these metals were expected to mix with the organic material. Surprisingly, the zinc and magnesium contents were also relatively high, this was probably because zinc oxide is used as a filler for automobile tires. Other elements in the ash were relatively low quantities; it is not clear whether compounds derived from these elements will leach into the environment if they were not properly disposed. A true assessment of the fate of these elements will require leaching studies of both the ash and the char from the ASR pyrolysis.

TABLE 10
Elemental composition of ASR ash (The values were
determined using atomic absorption spectroscopy)

| | Composition | Composition |
|---|---|---|
| Elements | (mg/kg) or ppm | (wt %) |
| Aluminum (Al) | 22087 | 2.208 |
| Arsenic (As) | 20.6 | 0.00206 |
| Boron (B) | 512 | 0.0512 |
| Barium (Ba) | 4117 | 0.4117 |
| Ca (Calcium) | 78000 | 7.80 |
| Cadmium (Cd) | 7.55 | 0.00075 |
| Cobalt (Co) | 54.3 | 0.0054 |
| Chromium (Cr) | 312 | 0.0312 |
| Copper (Cu) | 29825 | 2.98 |
| Iron (Fe) | 52310 | 5.23 |
| Potassium (K) | 4500 | 0.450 |
| Magnesium (Mg) | 17600 | 1.760 |
| Manganese (Mn) | 1396 | 0.1396 |
| Molybdenum (Mo) | 61.0 | 0.0061 |
| Sodium (Na) | 6085 | 0.6085 |
| Nickel (Ni) | 369 | 0.0369 |
| Phosphorous (P) | 1700 | 0.1700 |
| Lead (Pb) | 275 | 0.0275 |
| Sulfur (S) | 10600 | 1.06 |
| Selenium (Se) | — | — |
| Silicon (Si) | 5982 | 0.5982 |
| Strontium (Sr) | 280 | 0.0280 |
| Zinc (Zn) | 19902 | 1.9902 |

### Thermogravimetric Analysis (TGA) of ASR

Thermogravimetric analysis (TGA) which normally shows the rate of weight loss and the degradation temperature of various materials was used to characterize the ASR as a guide to the selection of appropriate pyrolysis temperature for the feedstock. The TGA showed that there were variations in the thermograms because of the heterogeneity of the samples. However, in both samples there were four major decomposition peaks and a minor peak due to water loss that occurred below 100° C. The first major weight loss occurred between 200 and 300° C. and the size of this peak was different for the two samples. This peak was probably due to the release of hydrochloric acid from the polyvinyl chloride (PVC) component of the ASR. It is known that HCl is released between 200 to 300° C. when PVC is pyrolyzed; which is then followed by the decomposition of the hydrocarbon backbone of the PVC. The differences in the peak intensities of the two thermograms could be due to the different amounts of PVC in each sample. The peak between 270 and 350° C. could be due to lignocellulosic materials and other organic compounds. Cellulose and hemicelluloses normally decompose between 270 and 360° C. The hemicelluloses decomposition occurs at 260-270° C. while cellulose decomposition occurs between 350 and 370 C depending on the degree of crystallinity of the cellulose.

### ASR Pyrolysis Products

The pyrolysis of the ASR was carried out at several temperatures starting from 450° C. to 650° C. on both sand and red mud. The pyrolysis using sand as the heat transfer and fluidizing medium was used as a reference for comparison with the red mud. The pyrolysis of the ASR at 450° C. and 500° C. produced extremely viscous liquids that were difficult to handle and therefore no data was included in this report. On the other hand, the pyrolysis of ASR using red mud at 450° C. and 500° C. all produced very low viscosity liquids, which clearly showed the catalytic activity of the red mud. The pyrolysis data for the sand and red mud are shown in Table 11. The total liquid yields were 22-32% at all temperatures for the ASR which was relatively low compared to lignocellulosic biomass feedstocks (50-75%). The major contributing factor to the large differences between the ASR and woody biomass was their ash contents. Whereas most lignocellulosic feedstocks have ash content between 0.1 to 5%, in case of the ASR, the ash content was 35-40% and thus the relative organic content of the feedstock was very low. As the pyrolysis temperature was raised from 500° C. to 650° C., the total liquid content decreased from 33% to 22% in case of the sand and this was attributed to the thermal cracking of the pyrolysis liquids to gases and coke since the yields of both components increased with temperature while the yield of total liquids decreased with temperature increase (Table 11). The pyrolytic water content decreased with increasing temperature in the case of the pyrolysis on the sand. It is not clear why the pyrolytic water content decreased with increasing pyrolysis temperature.

In order to the assess the catalytic properties of the red mud as a suitable catalyst for the ASR pyrolysis, a sample of ASR was pyrolyzed using red mud as the pyrolysis medium while maintaining the same reaction temperature and the weight hourly space velocity. As can be seen in Table 11, at 550° C., the yield of total liquid product using red mud was similar to that of the pyrolysis of ASR using sand as the pyrolysis medium. However, the organic liquid fraction and pyrolytic water yields were significantly different. The red mud produced less organic liquid fraction and gas than the sand, but the pyrolytic water fraction was higher than that produced using sand as the pyrolysis medium. This clearly showed that the red mud converted some of the organic liquid fraction into water. The char and gas yields for both systems were similar.

TABLE 11
ASR pyrolysis product yields for
red mud and sand pyrolysis medium

| Pyrolysis | Product yield (wt %) | | | | |
|---|---|---|---|---|---|
| Temperature (° C.) | Total liquid | Organics | Water | Char | Gas |
| 550° C.-Sand | 33.50 | 23.30 | 11.46 | 38.00 | 28.50 |
| 600° C.-Sand | 27.44 | 18.25 | 9.19 | 40.47 | 32.09 |
| 650° C.-Sand | 22.04 | 14.09 | 7.96 | 41.94 | 36.02 |
| 550° C.-Red Mud | 32.60 | 18.30 | 14.30 | 38.22 | 29.18 |

The composition of the pyrolysis gases produced at 550° C. for both the sand and the red mud are shown in Table 12. Although the mass yields of the pyrolytic gases produced using the different pyrolysis media were similar, their molar compositions were very different. In the case of the sand pyrolysis, the dominant gases were CO2 and CO which constituted about 65% of the total gases generated. Hydrogen and low molecular weight hydrocarbons made up the rest of the gases.

In contrast, in the red mud pyrolysis, the dominant gas was hydrogen which constituted over 42% of the total gases generated and was more than the CO2 and CO combined. The light hydrocarbon content of the gases was similar to that of the sand pyrolysis medium. Clearly the large fraction of hydrogen produced by the red mud was similar to that observed for the olive mill wastewater sludge (OMWS) pyrolysis where hydrogen constituted about 45% of the pyrolytic gases. The large production of hydrogen was attributed to the formation of olefins and cyclization of straight chain hydrocarbons into aromatic compounds and the release of hydrogen from the process. The hydrogen produced using the red mud was 2.8 times higher than that produced using the sand. It appears the sand was not capable of olefinic bond formation nor was it able to cause cyclization of the straight chain hydrocarbons in the pyrolysis products. This is a clear demonstration of the catalytic properties of the red mud compared to the sand. These results are in agreement with the catalytic effect of red mud on the pyrolysis of pinyon juniper reported by Yathavan and Agblevor (2013). The red mud pyrolytic gases consequently had a much higher calorific value than the corresponding sand pyrolytic gases which is major distinction between the two gases. Potentially, the red mud pyrolytic gases can be used to supply energy to the pyrolysis process if the gases are combusted.

TABLE 12
Gas chromatographic analysis of pyrolysis
gases of red mud and sand pyrolysis media.

| Gas (mol %) | 550° C.-Sand | 550° C.-Red Mud |
|---|---|---|
| H2 | 15.32 | 42.51 |
| CO | 15.69 | 12.60 |
| CO₂ | 49.55 | 28.03 |
| CH₄ | 4.75 | 4.93 |
| C₂H₆ | 0.56 | 0.58 |
| C₃H₈ | 5.47 | 4.73 |
| C₄H₁₀ | 4.81 | 3.93 |
| C₅H₁₂ | 3.22 | 2.26 |
| C₆H₁₄ | 0.63 | 0.43 |

The char analysis showed that the ash content was extremely high. For all samples the ash content was over 70% (Table 13) and consequently the higher heating values (HHV) were very low. This material may not be suitable for combustion since it contained most of the elements in the ASR ash analysis. Potentially, the combustion of this material may release harmful pollutants into the environment.

TABLE 13
Ash content and higher heating values of ASR char

| Pyrolysis | | |
|---|---|---|
| temperature (° C.) | Ash content (wt %) | HHV (MJ/kg) |
| 550 | 75.84 | 10.93 |
| 600 | 74.08 | 8.67 |
| 650 | 71.31 | 8.33 |
| 550-red mud | 75.00 | 11.0 |

### Characterization of ASR Pyrolysis Oils

The pyrolysis oils collected from the ESP were characterized for their organic elemental composition, higher heating value (HHV), viscosity, density, and pH. The comparison of the viscosities of the sand pyrolysis sample and the red mud catalyzed sample clearly showed that the red mud catalysis improved the viscosity of the pyrolysis oils by about 30% and pH by 10%. The application of the red mud also improved the HHV of the oils. Thus overall, the use of the red mud as a catalyst improved the qualities of the pyrolysis oils. The improvements in the properties of the oils were also reflected in the organic elemental composition of the oils. The oxygen contents of the oils were reduced by more than 50% with red mud compared to the sand pyrolysis (Table 15).

TABLE 14
HHV and Viscosity analysis of ASR pyrolysis oils

| Pyrolysis | HHV | Viscosity | |
|---|---|---|---|
| Temperature (° C.) | (MJ/kg) | (cp) | pH |
| 550° C.-Sand | 43.39 | 9.11 | 5.34 |
| 600° C.-Sand | 43.74 | — | — |
| 650° C.-Sand | 42.72 | — | — |
| 550° C.-Red Mud | 45.14 | 6.11 | 5.92 |

TABLE 15
Element analysis of ASR pyrolysis oils

| Pyrolysis | | | | | | HHV |
|---|---|---|---|---|---|---|
| Temperature | N (%) | C (%) | H (%) | S (%) | O (%) | (MJ/kg) |
| 550° C.-Sand | 1.15 ± 0.13 | 83.95 ± 0.85 | 11.43 ± 0.12 | 0.00 | 3.47 ± 0.88 | 43.39 |
| 600° C.-Sand | 0.47 ± 0.13 | 82.46 ± 0.92 | 11.92 ± 0.16 | 0.00 | 5.15 ± 1.14 | 43.74 |
| 650° C.-Sand | 0.73 ± 0.00 | 83.54 ± 0.32 | 11.26 ± 0.07 | 0.00 | 4.47 ± 0.39 | 42.72 |
| 550° C.-Red | 0.99 ± 0.04 | 85.61 ± 0.01 | 11.73 ± 0.03 | 0.28 | 1.67 ± 0.01 | 45.14 |
| Mud | | | | | | |
| 500° C.-red | 1.67 | 85.75 | 10.41 | 0.24 | 1.93 | |
| mud | | | | | | |
| 450° C.-red | 1.33 | 82.24 | 10.39 | 0.00 | 6.04 | |
| mud | | | | | | |

### Temperature Effects on Red Mud Pyrolysis Oil, pH, and Chlorine Removal

The application of the red mud for the pyrolysis of the ASR greatly improved the oil properties. Further studies were conducted to assess the effectiveness of the red mud in de-chlorinating the PVC in the ASR. The presence of PVC in the ASR contributes to the formation of polychlorinated biphenyls (PCBs) in the pyrolysis oils thus reducing its value as a transportation fuel (EPA limits for PCBs in number 2 diesel fuel is 2 ppm). The total halogen contents of several ASR red mud pyrolysis oil samples were determined and their corresponding pH values were measured and correlated with their total halogen content. There was a quadratic relationship between the pH and the total halogen content of the oils as shown by equation 3 below. The r² value of the correlation was 1. As the pH of the oil increased the halogen content decreased.

Y=8.2882*x²−11.402*x+7.0189 (3)

where Y=pH of oil; x=halogen content of oil (%).

A comparison of the ASR red mud pyrolysis oils produced at three different temperatures (450, 500, 550° C.) clearly showed that as the pyrolysis temperature increased the pH of the oils increased (Table 16) which suggests that red mud dechlorinated the PVC component of the ASR. This is an important finding because it reveals an important advantage of using red mud as a pyrolysis catalyst over conventional catalysts. Not only did the red mud crack the long chain hydrocarbons to produce a high naphtha fuel, but it also dechlorinated the oil to make it more suitable for application as transportation fuel. The variation of pH with temperature also followed a quadratic function, but in this case the slope was positive in contrast to the negative slope for the pH vs. halogen relationship. Halogen content was zero. This observation implies that the resulting oils will be PCB-free.

TABLE 16
Relationship between pH and pyrolysis
temperature and halogen content

| | Oil pH |
|---|---|
| Pyrolysis temperature (° C.) | |
| 450 | 5.32 |
| 500 | 6.44 |
| 550 | 6.67 |
| Halogen content (%) | |
| 0.024 | 6.75 |
| 0.170 | 5.32 |
| 0.617 | 3.14 |

Similar to improvement in the pH of the ASR red mud pyrolysis oils, there was also improvement in the viscosity of the ASR oils. The addition of CaO to the red mud improved the viscosities of the oils considerably. It appeared that the CaO also enhanced the cracking of the pyrolysis oil of long chain hydrocarbons in addition to removing the halogens from the ASR.

PCBs in ASR Oil and In Situ Removal with Modified Red Mud.

The analysis of the ASR pyrolysis oil using sand as a pyrolysis medium showed several types of polychlorinated biphenyl compounds (Table 17). The most abundant class was compounds with three chlorine atoms attached to the ring which had the highest concentration of 31.2 ppm. The total concentration of PCBs in the oil was relatively high and makes the oil unacceptable for transportation and other applications. The red mud was investigated both for catalytic cracking and chlorine removal. The pyrolysis results confirmed that red mud and red mud modified with calcium oxide shifted the pH of the oil from acidic to neutral and removed the PCBs from the oils. This action appeared to be the reaction of the red mud and modified red mud with the initial hydrochloric acid formed from PVC decomposition, which were not available for the further reaction to form PCBs.

TABLE 17
PCB analysis of ASR pyrolysis oils produced
using sand as pyrolysis medium

| | Peak | | Estimated | Class | Class |
|---|---|---|---|---|---|
| | retention | RIC peak | amount | total, | total, |
| #chlorines | time, (min) | area | (mg/l) | (mg/l) | (mg/kg) |
| 1 | nd | | <1.0 | | |
| 2 | 24.93 | 161053 | 4.5 | 4.5 | 5.2 |
| 3 | 26.73 | 208281 | 6.5 | | |
| | 27.52 | 79479 | 2.5 | | |
| | 28.59 | 326921 | 10.2 | | |
| | 29.01 | 154206 | 4.8 | | |
| | 29.32 | 102943 | 3.2 | 27.2 | 31.2 |
| 4 | 30.01 | 71871 | 2.2 | | |
| | 30.17 | 49256 | 1.5 | | |
| | 30.81 | 42969 | 1.3 | | |
| | 31.33 | 98491 | 3.0 | 8.1 | 9.3 |
| 5 | nd | | <1.0 | | |
| 6 | 35.60 | 62804 | 2.1 | | |
| | 36.49 | 112527 | 3.8 | | |
| | 37.50 | 71135 | 2.4 | 8.4 | 9.7 |
| 7 | 38.10 | 63682 | 2.4 | | |
| | 38.27 | 28379 | 1.1 | | |
| | 38.95 | 35579 | 1.3 | | |
| | 39.90 | 110759 | 4.1 | | |
| | 40.94 | 42441 | 1.6 | 10.4 | 12.0 |
| 8 | 41.23 | 17941 | 0.7 | | |
| | 41.43 | 22863 | 0.9 | 1.6 | 1.9 |
| 9 | nd | | <1.0 | | |
| 10 | nd | | <1.0 | | |

The pyrolysis of ASR with sand and red mud clearly showed that the red mud catalyzed the pyrolysis reaction and improved the properties of the both the pyrolysis oils and the pyrolysis gases. The viscosity of the pyrolysis oils were greatly improved using the red mud as catalyst compared to the sand pyrolysis. The red mud pyrolysis of ASR produced about 2.8 times more hydrogen than sand pyrolysis and produced much less CO2 and thus increasing the calorific value of the pyrolysis gases. The red mud also dechlorinated the ASR and thus enhancing the value of the ASR pyrolysis oils as transportation fuels. The red mud increased the naphtha content of the pyrolysis oils and thus increasing the gasoline yield of the ASR red mud pyrolysis oils.

The ASR pyrolysis oils had a high kerosene fraction which could be fractionated into diesel and jet fuels. The red mud deoxygenated the ASR more than 50% relative to the sand pyrolysis oils. Thus the red mud pyrolysis oils had less than 2% oxygen content. The dechlorination capacity of the red mud was increased by doping the red mud with CaO in the range of 5 to 10%. The addition of suitable amounts of CaO is able to remove all the acidic components in the oil and make the pH of the oil neutral.

The red mud deactivated after four hours pyrolysis, but the activity was restored after burning off the carbon deposits on the surface of the red mud at 550° C. for three hours. The red mud became magnetic after pyrolysis because of the transformation of the hematite to magnetite under the reducing pyrolysis conditions.

### Pinion and Juniper

We investigated the fractional catalytic pyrolysis of PJ using both HZSM-5 catalyst and red mud at 475° C. in a fluidized bed reactor at atmospheric pressure. Both the HZSM-5 and the red mud were effective catalysts for producing low viscosity pyrolysis oils. The red mud catalyzed oils had a lower viscosity (96 cP @40° C.) than the HZSM-5 catalyzed oils (213 cP @40° C.). In both cases, the yields of liquids ranged from 42 to 49 wt %. The mechanisms of catalysis by the two catalysts were quite different. Whereas the HZSM-5 rejected oxygen mostly as carbon monoxide and produced lower amounts of carbon dioxide, on the contrary the red mud produced more carbon dioxide and less carbon monoxide. Both catalysts produced similar amounts of water. The char/coke yields from both catalysts were similar but the total gas yields were slightly different. The higher heating value of the red mud catalyzed oil (29.46 MJ/kg) was slightly higher than that catalyzed by HZSM-5 (28.55 MJ/kg). Thus, red mud can be used to achieve alternative catalytic pyrolysis results as HZSM-5 catalysts.

Pinyon juniper (PJ) biomass chips were supplied by the USA Bureau of Land Management. The pinyon pine and juniper trees are usually harvested together, thus in order to represent the mixture, pinyon pine and juniper wood were manually mixed in ratio of 50:50 wt %. Wood samples were dried to equilibrium moisture content under ambient laboratory conditions and then ground in Wiley mill (model 4) until all the biomass passed through 1-mm screen.

A commercial catalyst, ZSM-5 was obtained from BASF Catalysts LLC (Iselin, N.J., USA) and calcined at 550° C. for 5 hours, to convert ZSM-5 into protonated form (HZSM-5). The catalyst was sieved to obtain particle size of 125-180 μm. The Brunauer-Emmett-Teller (BET) method was used to measure the surface areas of the catalyst using Quantachrome BET surface analyzer (Quantachrome Instruments, Boyton Beach, Fla.).

The red mud supplied by Sherwin Alumina Co LLC, (Gregory, Tex.), was dried, ground and sieved to appropriate particle size (125-180 μm) for fluidized bed pyrolysis studies. The composition of the red mud was determined by x-ray diffraction (XRD) using X'Pert Pro XRD spectrometer (PANanalytic Inc, Westborough, Mass.) and x-ray florescence (XRF) using Phillips PW2404 XRF spectrometer (PANanalytic Inc, Westborough, Mass.) and its surface area was determined using the Quantachrome BET surface analyzer.

### Biomass Characterization

The biomass was characterized on the basis of moisture, ash content, elemental composition and higher heating value (Table 18). The moisture content of the biomass was determined according to ASTM E1756-08 standard method; the ash content of the biomass was determined using ASTM E1755-01 standard method; the elemental composition (C, H, N, S, and O) of biomass was determined using the organic elemental analyzer (Flash 2000, Thermo scientific CHNS-O analyzer), but the oxygen was calculated by difference. The higher heating value (HHV) of the samples was determined using IKA C2000 basic bomb calorimeter (IKA® Works Inc, NC, USA).

TABLE 18
Composition and higher heating value of pinyon-juniper biomass.

| | |
|---|---|
| Moisture (wt %) | 7.55 ± 0.06 |
| Ash content (wt %) | 0.46 ± 0.04 |
| Carbon (wt %) | 53.43 ± 0.11 |
| Hydrogen (wt %) | 6.58 ± 0.04 |
| Nitrogen (wt %) | 0.16 ± 0.01 |
| Sulfur (wt %) | 0.00 |
| Oxygen (wt %) * | 39.37 ± 0.09 |
| Experimental HHV (MJ/kg) | 19.54 ± 0.16 |

* Oxygen by difference

### Pyrolysis of Biomass

The pyrolysis of the biomass feedstocks was conducted in a 51-mm (2-inch) fluidized bed reactor (see FIG. 2). Thus, the ground biomass was fed into a hopper and conveyed by K-Tron screw feeder into an entrainment zone where it was entrained by nitrogen carrier gas and transported through an air-cooled feeder tube into the bubbling fluid bed. The bubbling fluid bed medium was either sand or catalyst (100 g) depending on the desired outcome. The pyrolysis was conducted at 475° C. at atmospheric pressure. The fluidizing gas was nitrogen at a flow rate of three times the minimum fluidization velocity for catalytic (6.5 L/min) and non-catalytic pyrolysis (15 L/min). The biomass feed rate was 150 g/h and weight hourly space velocity was 1.5 h⁻¹.

The pyrolysis products exiting the reactor were first separated with a hot gas filter to collect the solid residue and some entrained catalyst. The vapors and non-condensable gases exiting the hot gas filter were then passed through two ethylene glycol cooled condensers maintained at 10° C. and 4° C. respectively to condense the pyrolysis vapors. The non-condensable gases and aerosols were then passed through an electrostatic precipitator (ESP) maintained at 20 kV to condense the aerosols. The clean non-condensable gases (NCG) were then passed through a coalescing filter and a totalizer and sampled online with Varian microGC gas chromatographic analyzer (Agilent Technologies, Santa Clara, Calif., USA). The excess gases were vented through a flare. All the reaction apparatus (reactor, hot gas filter, condensers, electrostatic precipitator) were weighed before and after each experiment. This enabled gravimetric determination of the yield of various products. The pyrolysis times were 120 to 180 min. In order to determine the catalyst activity, oil samples were collected at 60 min intervals and their viscosities measured. Additionally the gaseous products were analyzed every 7 min to follow the composition of the NCG which is related to the catalyst activity. All experiments were conducted in triplicates to determine reproducibility. In addition, some red mud catalyst was regenerated after the first run and reused for the pyrolysis.

### Gas Analysis

A fraction of the non-condensable gases (NCG) exiting the totalizer (0.1 L/min) was connected to Varian 490-microGC for online analysis. The NCG was automatically sampled every 7 min for the duration of the experiment. The microGC was equipped with two modules; a 10 m Molsieve 5A (MS) column, and a 10 m porous polymer (PPU) column. Each module had a thermal conductivity detector. The MS was used to analyze hydrogen, methane, and carbon monoxide while carbon dioxide, C₁-C₅ hydrocarbons were analyzed on the PPU column.

### Bio-Oil Analysis

The physico-chemical properties of the pyrolysis oil samples were characterized using several methods described below. The pH was measured using Mettler Toledo pH Meter and probe (Mettler-Toledo GmbH, Switzerland). The pH data were obtained after 5-10 min stabilization of the mechanically stirred oil. The dynamic viscosities and densities of the oils were measured at 40° C. using Anton Parr Stabinger viscometer svm 3000 (Anton Paar USA Inc, Ashland, Va., USA). A Metrohm 701KF Titrino (Brinkmann Instruments Inc, NY USA) and 703 titration stand setup were used for the volumetric Karl Fischer titration. Hydranal®-Composite 5 reagent was used for the titration. 50 ml methanol was placed in the titration vessel and conditioned. About 60-100 mg of the oil sample was loaded into a hypodermic plastic syringe and weighed. The sample was injected into the titration solvent and the syringe was reweighed. The water content was titrated volumetrically and the percentage mass recorded. The elemental composition (CHNOS) was determined using ThermoFischer Scientific Flash 2000 organic elemental analyzer, but the oxygen content was calculated by difference; the higher heating value (HHV) was determined using IKA C2000 basic bomb calorimeter. The ¹³C-NMR spectra were recorded on a JOEL 300 MHz NMR spectrometer (JOEL Ltd, Tokyo, Japan). About 1.0 g of oil was dissolved in 0.6 ml deuterated dimethyl sulfoxide-d₆ (DMSO-d₆) in a 5 mm sample probe. The DMSO-d₆ containing 1% (v/v) tetramethylsilane (TMS) was obtained from Sigma Aldrich (Sigma Aldrich, St Louis, Mo. USA). The observing frequency for the ¹³C nucleus was 100.58 MHz, the pulse width was 10 μs, the acquisition time was 1.58 s, and the relaxation delay was 2 s. The spectra were obtained with 3000 scans and a sweep width of 20 kHz.

### Catalyst Characterization

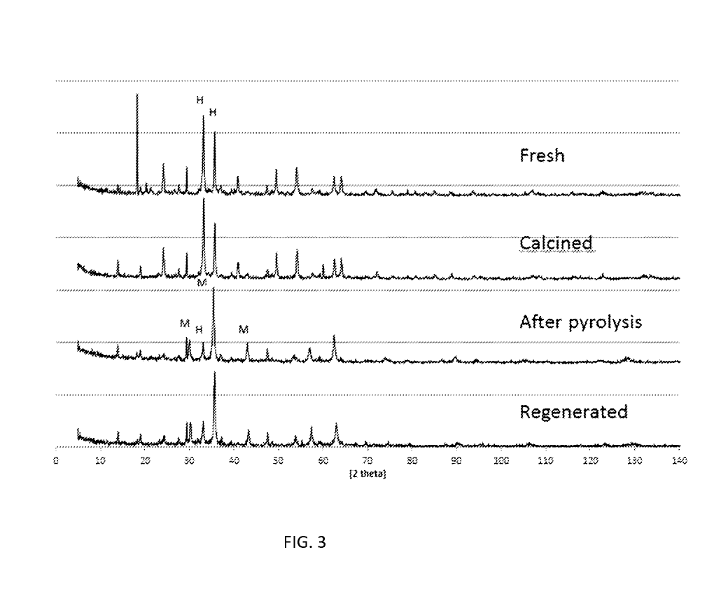

The BET surface area of the HZSM-5 catalyst used for the pyrolysis was 115 m²/g. The red mud water slurry had a pH 9 and the dry ground material used for the experiments had a BET surface area 30 m²/g. The XRF analysis showed that the red mud was composed of the following major metal oxides (wt %): Fe₂O₃ (53.98), Al₂O₃ (13.53), SiO₂ (8.91), CaO (8.87), TiO₂ (6.18), and Na₂O (5.83). The presence of these oxides was further confirmed with XRD analysis. There was no activation of the red mud before being used, thus, the reported effect is on as received basis. The red mud samples were heated in the reactor for almost two hours to get to a stable pyrolysis temperature before each reaction. The red mud did not have any magnetic properties before the pyrolysis, but after pyrolysis it had magnetic properties. The change in properties of the red mud was attributed to the conversion of hematite (Fe₂O₃) to magnetite (Fe₃O₄) under the pyrolysis conditions. The 2 theta signals observed in x-ray diffraction spectra before and after the pyrolysis were typical of hematite and magnetite (see FIG. 3).

The CO concentration in the total PJ pyrolysis gas (NCG plus nitrogen) was 2.7 vol % and the hydrogen was less than 0.1 vol %; these gas concentrations were not optimal for hematite reduction, but they were sufficient for partial conversion of hematite to magnetite which resulted in a mixture of oxides.

When a similar pyrolysis reaction was conducted using pure Fe₂O₃, the reduction in viscosity of the pyrolysis oil was much less, which suggested that other components in the red mud were also participating in the catalysis of the biomass during pyrolysis.

In order to study the effect of preheating the red mud in the reactor before the pyrolysis, the red mud was calcined at 550° C. for 5 hours in a furnace; the XRD pattern obtained demonstrated that no magnetite was formed. The calcination, pyrolysis, and regeneration introduced other changes in the structure of the red mud. The 2 theta signals between 10° and 20° had reduced intensities after calcination, regeneration, or pyrolysis, because of the decomposition of Gibbsite to alumina. It is also interesting to note that the calcinations of the red mud did not influence the hematite properties of the iron oxide because the atmosphere was oxidative. Similarly, the catalyst regeneration during which the coke/char was burned off the surface of the catalysts was also oxidative and did not cause any phase change of the catalyst, thus the regenerated catalyst had similar composition as the red mud after pyrolysis.

### Pyrolysis Products Distribution

The pyrolysis products distribution for PJ biomass using various pyrolysis media is shown in Table 19 for pyrolysis lasting two hours. The liquid products were segregated in the three condensers; most of the aqueous fraction was found in the first condenser, while the oil collected in the electrostatic precipitator (ESP) had low moisture content. However, the properties of the organic phase of the condenser liquids were similar to those from the ESP oils. In the case of the silica sand (sand) pyrolysis, the aqueous phase was miscible with the organic fraction whereas in the cases of HZSM-5 and red mud the aqueous phases were immiscible with the organic phases because the oils were more deoxygenated, which made them less polar than the sand pyrolysis oil (Table 20).

TABLE 19
Pyrolysis products distribution of pinyon-juniper
biomass pyrolyzed using various pyrolysis medium.

| Pyrolysis | Product distribution (wt % dry basis) | | | | |
|---|---|---|---|---|---|
| medium | Total liquid | Organic liquid | Water | Char | Gas* |
| Sand | 60.31 ± 0.05 | 40.15 ± 0.51 | 20.16 ± 0.55 | 22.49 ± 0.39 | 17.21 ± 0.34 |
| HZSM-5 | 49.34 ± 0.14 | 25.92 ± 0.11 | 23.42 ± 0.25 | 20.98 ± 0.32 | 29.69 ± 0.18 |
| Red mud | 44.37 ± 1.02 | 20.85 ± 1.0 | 23.53 ± 0.02 | 23.50 ± 0.21 | 32.14 ± 1.23 |

The HZSM-5 and red mud pyrolysis decreased the total liquid yield relative to that from the sand. The loss in total liquid yield was mostly due to the production of large amounts of gaseous products (carbon oxides) from the organic fraction. The reduction in the organic liquid yield was attributed to deoxygenation and cracking of the pyrolysis vapors by the catalysts. The conversion of the organic liquid to water and char/coke by the catalysts was relatively low compared to the amount of gas produced. The water yields of HZSM-5 and red mud were only slightly different from that due to the sand (Table 19).

The char/coke yields for the HZSM-5 and the red mud were similar but slightly higher than that for the sand (Table 19). These char/coke yields were relatively low because in this process, the species in contact with the catalyst are unstable pyrolysis intermediates, whereas in traditional pyrolysis upgrading systems, the compounds in contact with the catalyst are stable molecules which promote coke formation. The pyrolysis medium greatly influenced the yield of gaseous products. The sand produced the least amount of gas whereas the red mud produced the highest amount of gas due to its ability to crack the pyrolysis vapors.

### Properties of Catalytic Pyrolysis Oils

Because the ESP captured most of the oil product with minimal water content, this fraction was used for the characterization studies. The oil phase from the second condenser had similar properties like the ESP oil and therefore data from the ESP oils were representative of the total oils produced from this process. The physico-chemical properties of the oils from the ESP are shown in Table 20. It can be seen that the moisture content of the ESP oils were very low because of the efficient condensation of the aqueous fractions in the ethylene glycol cooled condensers. The pH of red mud oil was higher than those of the sand and HZSM-5 oils probably because of the improved decarboxylation of some of the acidic groups. The densities of the red mud oils were also slightly lower than those of the sand and HZSM-5, although they were all higher than the density of water. The dynamic viscosities of the oils showed dramatic differences. The red mud oils were about seven times less viscous than the sand oils whereas the HZSM-5 oils were only three times less viscous. These major differences were attributed to the cracking of the oils by the red mud and the HZSM-5 which resulted in high gas production. The relative carbon content of the red mud oils was 14% higher than that of the sand oil and its oxygen content was 25% lower than that of the sand oil. The hydrogen content of the red mud pyrolysis oils were also slightly higher than those of the sand oil and HZSM-5 oils probably because most of the oxygen was rejected as carbon dioxide and less as water. There were significant differences in the higher heating values (HHV) of the oils. Both the red mud and HZSM-5 oils had much higher HHV than the sand oil.

TABLE 20
Physico-chemical properties of pyrolysis oils
collected from the electrostatic precipitator

| Properties | Sand | HZSM-5 | Red mud |
|---|---|---|---|
| Water | 2.81 ± 0.15 | 1.72 ± 0.08 | 1.45 ± 0.08 |
| content (wt %) | | | |
| pH | 2.75 | 2.80 ± 0.10 | 3.56 |
| Density (g cm⁻³) | 1.22 ± 0.02 | 1.19 ± 0.04 | 1.14 ± 0.01 |
| Dynamic | 686.02 ± 27.52 | 213.68 ± 10.14 | 96.99 ± 19.54 |
| Viscosity (cP) | | | |
| Carbon (wt %) | 58.11 ± 0.07 | 62.79 ± 0.10 | 65.13 ± 0.05 |
| Hydrogen (wt %) | 6.72 ± 0.04 | 6.86 ± 0.04 | 7.17 ± 0.01 |
| Nitrogen (wt %) | 0.13 ± 0.02 | 0.27 ± 0.03 | 0.21 ± 0.02 |
| Oxygen (wt %)* | 35.04 | 30.08 | 27.49 |
| HHV (MJ/kg) | 24.87 ± 0.37 | 28.55 ± 0.23 | 29.46 ± 0.62 |

The functional groups present in the pyrolysis oils were characterized by semi-quantitative integration of the ¹³C-NMR spectra. The semi-quantitative analysis of the ¹³C-NMR functional groups show that pyrolysis with sand produced more highly oxygenated oils that had higher amounts of carbohydrate degradation products, alcohol, ethers, methoxylated phenols, carboxylic groups, aldehydes, and ketones (Table 21). The catalytic pyrolysis oils had lower concentrations of carbohydrate degradation products, alcohols and ethers, while the aliphatics and aromatic products were relatively higher than that from sand. The carboxylic acids, ketones, and aldehydes concentrations were also relatively lower than that of the sand.

TABLE 21
Functional group distribution of catalytic and non-catalytic
pyrolysis oils from ¹³C-NMR spectral integration.

| | Chemical | | | |
|---|---|---|---|---|
| Functional groups | shift (δ ppm) | Sand | HZSM-5 | Red mud |
| Aliphatics | 0-55 | 17.70 | 20.21 | 26.03 |
| Methoxyl in lignin | 55-57 | 8.22 | 6.72 | 5.04 |
| Levoglucosan | 60-105 | 30.04 | 16.08 | 12.45 |
| Aromatics | 105-160 | 38.03 | 53.74 | 53.93 |
| Carboxylic acids | 160-180 | 3.73 | 1.99 | 1.51 |
| Ketones and aldehydes | 180-210 | 2.29 | 1.26 | 1.05 |

The comparison between HZSM-5 and red mud pyrolysis oils spectra showed that the later was more effective in the conversion of the carbohydrate degradation products into other compounds (Table 21). The relative amounts of aromatic compounds produced by the red mud were similar to HZSM-5, but there were more aliphatic carbon signals in the red mud oils than the HZSM-5 oils. The increased aliphatic signal intensity was attributed to increased demethoxylation of the lignin moieties which resulted in the production of methanol and subsequent alkylation reactions. The methanol signal at 50 ppm was much higher for the red mud oil than the other two oils.

### Pyrolysis Gases

The pyrolysis gas components were similar for all the pyrolysis media, but varied in their individual concentrations. All pyrolysis gases contained CO, CO₂, and C₁-C₅ hydrocarbons (Table 22) with CO and CO₂ constituting 84-90% of all gases. The CO₂ contents were highest for the sand and red mud pyrolysis gases. In contrast HZSM-5 pyrolysis gases had the highest CO content and red mud pyrolysis gases had the lowest CO content. The main difference in the carbon oxide contents of the gases may be due to differences in reaction pathways. In the case of the sand, the carbon oxides production was attributed to thermal cracking whereas in the cases of HZSM-5 and red mud, there appeared to be catalytic cracking. The catalytic rejection of oxygen from the biomass appeared to be through production of H₂O, CO, and CO₂. The catalytic CO and CO₂ production from biomass pyrolysis could be through decarbonylation, ketonization, decarboxylation or all three pathways. In the case of the HZSM-5 it appeared the decarbonylation reaction was dominant producing more CO than CO₂.

TABLE 22
The yield of various gases using different pyrolysis
medium. The yield is expressed as a percentage
of the biomass feed (wt % dry basis).

| Gases | Sand | HZSM-5 | Red mud |
|---|---|---|---|
| Hydrogen | 0.14 ± 0.02 | 0.19 ± 0.02 | 0.49 ± 0.12 |
| Methane | 0.50 ± 0.05 | 1.21 ± 0.08 | 1.59 ± 0.16 |
| Carbon monoxide | 5.41 ± 0.81 | 14.27 ± 0.56 | 9.21 ± 0.27 |
| Carbon dioxide | 10.30 ± 0.34 | 10.85 ± 0.05 | 18.51 ± 0.41 |
| Ethane | 0.09 ± 0.01 | 0.67 ± 0.02 | 0.36 ± 0.01 |
| Propane | 0.31 ± 0.02 | 0.64 ± 0.01 | 0.37 ± 0.04 |
| N-butane | 0.25 ± 0.14 | 2.06 ± 0.05 | 1.37 ± 0.24 |
| N-pentane | 0.21 ± 0.02 | 0.27 ± 0.06 | 0.23 ± 0.03 |
| Total | 17.21 ± 1.37 | 29.69 ± 1.01 | 32.14 ± 1.28 |

In the case of the red mud catalysis, the CO₂ production was more pronounced than CO. The CO₂ production from the red mud was attributed to catalytic activity instead of thermal cracking because the organic liquids produced had lower oxygen, higher carbon, and lower viscosity than those produced from the sand (Table 20). Oxygen rejection from the pyrolysis products was probably through decarboxylation reactions because the relative amounts of carboxylic acids and ketones were lower for the red mud oil compared to the HZSM-5 and sand oils (Table 21). The ¹³C-NMR carboxylic acid signal for the red mud oil was less than one half that from the sand oil. Oxygen rejection through CO₂ is known as through ketonization reactions, which converted carboxylic acids to ketones and released CO₂. Thus, if the high CO₂ production from the red mud reaction proceeded through ketonization pathway, then an increase in the ¹³C-NMR ketone signals and a decrease in the carboxylic carbon signal relative to the sand should be apparent, but this was not observed.

The higher CO₂ production from the red mud catalyzed pyrolysis could also be due to contribution from the reduction of hematite to magnetite. It is known that under low hydrogen and CO concentrations at 150-400° C. and atmospheric pressure, hematite was reduced to magnetite with the subsequent release of CO₂ and H₂O as shown in equations 4 and 5. The pyrolysis gas composition showed the presence of both H₂ and CO and the red mud after pyrolysis had magnetic properties; thus it is plausible that some of the CO₂ originated from the reduction of hematite to magnetite. The XRD data of the red mud after the pyrolysis also confirmed the formation of magnetite.

3Fe₂O₃+H₂=2Fe₃O₄+H₂O (4)

3Fe₂O₃+CO=2Fe₃O₄+CO₂ (5)

The contribution of CO₂ from the reduction of hematite to magnetite was presumed minimal because reaction (2) is very rapid and the CO₂ will be released within a few minutes from the start of the pyrolysis reaction. Furthermore, this assertion is supported by the regenerated catalyst (magnetite/hematite) pyrolysis data which had similar CO/CO₂ ratio for the fresh and regenerated catalyst pyrolysis. During the red mud catalytic pyrolysis, the catalyst was partially transformed into magnetite/hematite and regeneration did not cause any phase change in the catalyst because of the oxidative nature of the process.

Oxygen rejection as H₂O was similar for the two catalysts since the H₂O yields were similar and higher than that of the sand. The hydrogen yield also varied according the pyrolysis medium. The highest hydrogen production was from the red mud medium whereas the sand produced the lowest amount of hydrogen. The concentrations of hydrocarbons also increased for catalytic pyrolysis compared to non-catalytic pyrolysis. Butane accounted for about 39% of hydrocarbons for both catalysts and methane accounted for 27% and 37% of hydrocarbons respectively in HZSM-5 and red mud.

### Catalyst Deactivation and Regeneration

The activity of the catalyst was monitored through the variation of CO and CO₂ concentration over time. The average CO/CO₂ ratio for sand was constant at about 0.6 throughout the pyrolysis process. The ratio of CO/CO₂ for HZSM-5 was high during the first hour (1.8-1.4) but decreased during the second hour to a constant value of 1.0. Thus, the catalyst was most active during the first 60 minutes, but the activity decreased sharply during the second hour and remained constant thereafter. Since the CO/CO₂ ratio did not decrease to the value of the sand, this suggested that there was some residual activity in the catalyst. During the first 60 min of pyrolysis, no significant amount of oil accumulated in the ESP and most of the product was gas, but after 120 min a significant amount of oil accumulated, which suggested that most of the oil was produced during the partially deactivated phase of the catalyst. The final oil collected after 120 min had a viscosity about threefold less than that of the sand pyrolysis oil (Table 20).

The red mud produced more CO₂ than CO and thus the CO/CO₂ ratio was below 1.0 throughout the experiment. During the first 60 minutes, CO/CO₂ ratio was lower than that of the sand, but the ratio increased gradually and was only slightly less than the sand ratio after 40 min. Even though the CO/CO₂ ratios of the sand and red mud were similar after 60 min of pyrolysis, the properties of the composite pyrolysis oils (total oils collected between 0 and 120 min) were significantly different (Table 20). The red mud pyrolysis oil was about seven times less viscous than the sand pyrolysis oil which suggested that the reaction pathway was different from that of the sand.

After three hour of continuous pyrolysis using red mud, the CO/CO₂ ratio and the viscosity of the oil suggested that the catalyst had deactivated significantly. The catalyst was then regenerated by burning the char/coke deposit in a muffler furnace at 550° C. for five hours. The regenerated catalyst had magnetic properties which suggested that the hematite (Fe₂O₃) had been reduced to magnetite (Fe₃O₄) under the pyrolysis conditions. To verify that the change in properties of the red mud was not due to the regeneration process which is oxidative, cooled freshly discharged catalyst from the pyrolysis reactor was tested for magnetic activity; this showed positive magnetic activity. Additionally fresh red mud was calcinated at 550° C. for five hours and tested for magnetic activity, but this material did not possess any magnetic activity. The formation of magnetite was further confirmed by comparing the XRD spectra of fresh, regenerated, and calcinated red mud. Both hematite and magnetite have 2 theta signals at 35.2°, but for the regenerated catalyst, the intensity of this signal increased significantly. Furthermore, only magnetite has signal at 2 theta 30° and hematite has 2 theta signal at 33 degrees. The signals for both hematite and magnetite were detected in the regenerated catalyst confirming that some of the hematite was converted to magnetite under the pyrolysis conditions.

The pyrolysis product distributions of fresh and regenerated red mud were similar (data not shown). The physico-chemical properties of ESP oil from fresh and regenerated red mud collected at 60 minutes intervals during the pyrolysis are shown in Table 23. There was not much difference in pH, densities, elemental composition and energy content of the oils collected at different times for fresh red mud. The viscosity of the oil however increased with time and this suggested that fresh red mud lost some of its activity to break down larger molecules.

TABLE 23
Physico-chemical properties of pyrolysis oils from fresh and regenerated red mud.

| | Fresh red mud | | | Regenerated red mud | | |
|---|---|---|---|---|---|---|
| Properties | 60 min | 120 min | 180 min | 60 min | 120 min | 180 min |
| Water content (wt %) | 0.67 ± 0.11 | 0.93 ± 0.08 | 0.99 ± 0.07 | 1.80 ± 0.08 | 1.42 ± 0.02 | 1.15 ± 0.02 |
| pH | 3.41 ± 0.04 | 3.58 ± 0.06 | 3.49 ± 0.10 | 3.76 ± 0.05 | 3.65 ± 0.06 | 3.58 ± 0.05 |
| Density (gcm⁻³) | n/d | 1.26 ± 0.11 | 1.19 ± 0.10 | n/d | 1.14 ± 0.15 | 1.14 ± 0.18 |
| Dynamic Viscosity(cP) | n/d | 101.16 ± 8.79 | 120.25 ± 6.91 | n/d | 99.34 ± 6.44 | 122.81 ± 9.7 |
| Carbon (wt %) | 67.63 ± 0.41 | 67.10 ± 0.21 | 67.16 ± 0.09 | 66.03 ± 0.23 | 66.47 ± 0.08 | 66.55 ± 0.02 |
| Hydrogen (wt %) | 7.02 ± 0.12 | 7.09 ± 0.05 | 7.13 ± 0.02 | 7.21 ± 0.04 | 7.23 ± 0.01 | 7.27 ± 0.03 |
| Nitrogen (wt %) | 0.31 ± 0.03 | 0.29 ± 0.05 | 0.28 ± 0.03 | 0.24 ± 0.01 | 0.25 ± 0.02 | 0.23 ± 0.01 |
| Oxygen (wt %)* | 25.04 | 25.52 | 25.43 | 26.55 | 26.05 | 25.95 |

The physico-chemical properties of ESP oil from regenerated red mud showed that there was not much difference in density, pH, elemental composition and energy content of the oils collected at different time intervals. As observed for the fresh red mud pyrolysis oils, the viscosity of oil from regenerated red mud also increased with time on stream. Thus, with fresh and regenerated red mud, there was not much difference in the physical properties of the oils.

The chemical compositions of the pyrolysis oils from fresh and regenerated red mud were analyzed with ¹³C-NMR spectroscopy. The semi-quantitative integration of the ¹³C-NMR spectra are shown it Table 24. Clearly, the two oils were similar in the relative concentration of most functional groups, thus suggesting that the catalyst activity was fully restored after the regeneration. Furthermore, the variation in the CO/CO₂ ratio of the regenerated red mud and the fresh red mud also support the assertion that the regenerated catalyst had similar activities like the fresh red mud.

TABLE 24
Functional groups distribution (¹³C-NMR integration data) of
pyrolysis oils collected at different time intervals from the
pyrolysis of PJ biomass using fresh and regenerated red mud.

| Chemical shift | Fresh red mud | | | Regenerated red mud | | |
|---|---|---|---|---|---|---|
| δ(ppm) | 1 h | 2 h | 3 h | 1 h | 2 h | 3 h |
| 0-55 | 22.77 | 26.16 | 21.68 | 23.58 | 23.02 | 22.93 |
| 55-57 | 3.85 | 4.61 | 5.37 | 5.14 | 5.16 | 5.51 |
| 60-105 | 9.95 | 10.61 | 12.74 | 11.69 | 11.48 | 13.66 |
| 105-160 | 60.57 | 55.79 | 57.39 | 56.72 | 56.82 | 55.37 |
| 160-180 | 1.57 | 1.75 | 1.72 | 1.49 | 2.30 | 1.49 |
| 180-210 | 1.28 | 1.08 | 1.09 | 1.38 | 1.23 | 1.04 |

The comparative catalytic pyrolysis studies of HZSM-5 and red mud demonstrate that red mud can catalyze the fractional catalytic pyrolysis of biomass to generate pyrolysis oils with relatively lower viscosities than HZSM-5 catalyst. The viscosities of the pyrolysis oils generated using the two catalysts were significantly different from each other and the baseline sand pyrolysis oils. The red mud pyrolysis oils were about seven times less viscous than the baseline sand oils whiles the HZSM-5 oils were only three times less viscous than the sand oils even though the differences in their oxygen contents were not drastically different.

A major factor contributing to the increase in viscosity of pyrolysis oils during storage was the oligomeric products content. The oligomeric products isolated from the oils derived from both carbohydrate and lignin decomposition products. These methanol soluble oligomeric products were either solid or gel-like at room temperature. The higher the oligomeric products content, the higher the viscosity of the bio-oil. Applying this same concept to the HZSM-5, red mud, and sand oils in the current studies, this suggested that the red mud was more effective in decomposing the oligomeric products in the oil compared to the sand and HZSM-5. The other disadvantage of the HZSM-5 catalyst was the production of large quantities of gas during the early stages of the pyrolysis when the catalyst was extremely active and thus reducing liquid yields. The rejection of oxygen was also through the production of CO which led to excessive loss of carbon and thus reducing the overall carbon efficiency of the process.

Although the red mud pyrolysis process also generated large quantities of gas similar to the HZSM-5 pyrolysis inspite of its lower surface area; the gas was richer in CO₂ than the HZSM-5 gas and the oils had slightly lower oxygen content than the HZSM-5 pyrolysis oils. The catalytic activity of the HZSM-5 appeared to be more dependent on the internal surface area and once these were fouled with coke deposits the reaction rate decreased considerably. In contrast, the red mud catalytic activity appeared to be dependent on the external surface area which was about 3.8 times less than the HZSM-5 and yet the reactivity was maintained for about three hours. Since there was constant attrition of the particles in the fluid bed, the fouling of the exterior surface of the red mud was reduced considerably compared to the HZSM-5 and hence better quality oil was produced using this catalyst. The viscosity of pyrolysis oils generated from the red mud catalysis process also increased during the pyrolysis time on stream; however, the increase was less rapid than the HZSM-5. Both catalysts appeared to reach a steady or equilibrium state during which the rejection of carbon oxides did not vary very much with time on stream. The major advantage of the red mud catalyst is its apparent rejection of oxygen through CO₂ instead of CO and hence less consumption of carbon for oxygen rejection. The physico-chemical properties of the red mud oil also appeared to be slightly better than the HZSM-5 oils. Furthermore, red mud is a waste product of the Bayer alumina process and could therefore be procured at minimal cost and hence improve the economics of biomass catalytic pyrolysis process. Red mud could therefore be potentially used to replace HZSM-5 for catalytic biomass pyrolysis.

Pyrolysis of pinyonjuniper biomass was demonstrated using silica sand, HZSM-5, and red mud as effective pyrolysis media. The HZSM-5 and red mud had catalytic effect on the pyrolysis of the feedstock resulting in oils with much lower viscosity than the oils produced using silica sand as the pyrolysis medium. The pyrolysis oils generated using the red mud had viscosities that were seven times lower than the oils produced using the silica sand. The reaction pathway of the red mud was quite different from that of the HZSM-5 and silica sand, in that red mud rejected oxygen from the biomass pyrolysis vapors probably through decarboxylation reaction instead of the decarbonylation observed for the HZSM-5. The red mud appeared to be stable and regenerable for catalytic pyrolysis reactions.

It will be appreciated that variations of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

1. A method of producing bio-oil, comprising:
providing a catalyst bed in a fluid state, wherein the catalyst bed comprises red mud;
heating the catalyst bed to a temperature suitable for pyrolysis;
providing a flow of a non-reactive fluid onto the catalyst bed;
providing feedstock in the flow of non-reactive fluid;
pyrolyzing the feedstock.

2. The method of claim 1, wherein the catalyst bed is heated to a temperature of from about 400° C. to about 650° C.

3. The method of claim 1, wherein the catalyst is heated to a temperature of from about 425° C. to about 600° C.

4. The method of claim 1, further comprising collecting gasses and vapors from pyrolyzing the biomass and condensing the vapor into a bio-oil and recovering the non-condensable gases.

5. The method of claim 1, wherein the non-reactive fluid is pyrolysis gas.

6. The method of claim 1, wherein the non-reactive fluid is nitrogen gas.

7. The method of claim 1, wherein the feedstock is olive mill waste.

8. The method of claim 1, wherein the feedstock is automotive shredder residue.

9. The method of claim 8, wherein the method further comprises providing calcium oxide and incorporating the calcium oxide onto the red mud and catalyst bed.

10. The method of claim 1, wherein the feedstock is from virgin and waste vegetable oil or lipids.

11. The method of claim 1, wherein the feedstock is from plant matter.

12. A bio-oil prepared from the method of claim 7.

13. A bio-oil prepared from the method of claim 8.

14. A bio-oil prepared from the method of claim 10.

15. A bio-oil prepared from the method of claim 11.

16. A pyrolysis catalyst, comprising red mud.

17. The catalyst of claim 16, wherein the red mud comprises a mixture Fe₂O₃, Al₂O₃, SiO₂, CaO, TiO₂, and Na₂O.

18. The catalyst of claim 16, further comprising water in the form of a slurry having a pH of between about 8.5 and about 12.

19. The catalyst of claim 16, wherein the catalyst has a BET surface area of between about 30 and about 65 m2/g.

20. The catalyst of claim 16, wherein the catalyst further comprises magnetite.
